(19) United States
(12) Patent Application Publication
(10) Pub. No.: US 2026/0267893 A1
(43) Pub. Date: Sep. 10, 2026

(54) System and Method for Ricci-Flow Reasoning in Cognitive Machines

(71) Applicant: AtomBeam Technologies Inc., Moraga, CA (US)

(72) Inventor: Brian Galvin, Silverdale, WA (US)

(21) Appl. No.: 19/574,945

(22) Filed: Mar. 23, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/382,207, filed on Nov. 6, 2025, now Pat. No. 12,688,217.
Application No. 19/382,207 is a continuation of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06F 16/334

(52) U.S. Cl. CPC G06F 16/3347; G06F 11/1446; G06F 16/3329; G06F 16/353; G06F 18/21375; G06N 3/049; G06N 3/061

(57) ABSTRACT

A system and method for Ricci-flow reasoning in cognitive machines. A Ricci-flow reasoning engine performs bounded-time curvature-driven geometric evolution on selected regions of a persistent cognitive manifold to stabilize reasoning trajectories and clarify admissibility boundaries. The engine operates in multiple modes including pre-traversal preconditioning, trajectory-planning coupled evolution, in-traversal stabilization, post-traversal validation, and background maintenance. Multi-scale flow sequences address coarse structural instabilities before fine-grained regularization while selectively evolving compressive components and preserving shape-preserving components to prevent semantic drift. Comprehensive failure detection monitors for pressure persistence, admissibility collapse, invariant violation, and epistemic incompatibility. When failures are detected, hallucination-safe fallback behaviors enforce output suppression, preventing fabrication or extrapolation. Repeated failure patterns trigger irreversible suppression of invalid trajectory patterns. Aggregate rate control prevents excessive cumulative evolution across reasoning sessions. The disclosed techniques reduce hallucination, improve reasoning stability, and maintain epistemic discipline in persistent cognitive systems.

### CROSS-REFERENCE TO RELATED APPLICATIONS

Priority is claimed in the application data sheet to the following patents or patent applications, each of which is expressly incorporated herein by reference in its entirety:
Ser. No. 19/382,207
Ser. No. 19/550,709
Ser. No. 19/548,024
Ser. No. 19/546,407
Ser. No. 19/534,677
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention relates generally to artificial intelligence systems, and more particularly to systems and methods for implementing persistent cognitive capabilities in computing machines that extend beyond traditional prompt-response paradigms.

### Discussion of the State of the Art

Recent advancements in artificial intelligence have led to the development of powerful language processing technologies, including Large Language Models (LLMs) and Reasoning Models (RMs). These technologies have demonstrated impressive capabilities in natural language understanding, generation, and reasoning across numerous domains. The field has experienced significant growth since the introduction of transformer-based architectures, leading to models with increasingly sophisticated abilities to process and generate human-like text.

Large Language Models operate by predicting the most likely sequence of tokens that would follow a given input sequence. These models are trained on vast corpora of text data and generate contextually appropriate continuations by iteratively predicting the next most probable token based on the preceding sequence. Reasoning Models extend this architecture by generating a chain-of-thought when receiving an input sequence, and then using this chain-of-thought together with the original input to generate an improved output sequence, enabling more thorough logical reasoning and multi-step problem solving.

Despite their impressive capabilities, these technologies remain fundamentally limited by their operational paradigm. They function within a prompt-response framework wherein they await input, generate output, and then return to a waiting state. This discrete interaction model creates fundamental limitations: the model essentially resets between interactions, maintaining only the context explicitly provided within the current conversation or prompt window, and lacks any intrinsic ability to evolve over time or autonomously initiate processes when not directly engaged by a user.

Persistent Cognitive Machines, as disclosed in related applications incorporated herein by reference, address these limitations by maintaining structured internal cognitive state across interactions through a persistent cognitive manifold. Rather than resetting between interactions, a Persistent Cognitive Machine maintains awareness and cognitive processes across sessions, remembers previous experiences through a thought cache, and learns continuously from interactions. The persistent cognitive manifold organizes internal state as a structured space in which proximity, connectivity, and accessibility among representations are governed by geometric structure, enabling reasoning to occur through constrained traversal of admissible paths rather than unconstrained statistical sampling.

However, even within persistent cognitive architectures, reasoning trajectories may encounter instabilities arising from excessive curvature, structural congestion, or conflicting constraints within the cognitive manifold. Such instabilities can lead to erratic traversal behavior, ambiguous state transitions, or the generation of outputs that are not epistemically supported by the available evidence or structural commitments of the system. This phenomenon, commonly referred to as hallucination, represents a significant limitation of current artificial intelligence systems and undermines the reliability and trustworthiness of their outputs.

Existing approaches to mitigating hallucination typically rely on post hoc filtering, heuristic confidence scoring, or static constraint checks applied after candidate outputs are generated. These approaches operate on outputs rather than on the underlying geometric structure that governs reasoning traversal and therefore cannot proactively stabilize reasoning trajectories or sharpen admissibility boundaries prior to traversal. Furthermore, these approaches do not modify the persistent cognitive manifold itself and therefore provide no lasting improvement to manifold health or long-horizon reasoning stability.

Other approaches employ reinforcement learning from human feedback or constitutional training methods to reduce the frequency of hallucinated outputs. While these approaches can reduce hallucination rates during training, they do not provide structural guarantees at inference time and cannot enforce admissibility constraints based on accumulated evidence or prior irreversible commitments of a persistent cognitive architecture.

What is needed is a systems, methods, and reasoning mechanisms that operate directly on the geometric structure of persistent cognitive state, regularizing that structure in a controlled manner before, during, or after reasoning traversal. Such mechanisms should be capable of proactively stabilizing reasoning trajectories, enforcing invariant preservation, detecting and responding to failure conditions in a hallucination-safe manner, and improving long-horizon manifold health through adaptive mode selection and background maintenance.

### SUMMARY OF THE INVENTION

Accordingly, the inventor has conceived and reduced to practice, a system and method for Ricci-flow reasoning in cognitive machines. A Ricci-flow reasoning engine performs bounded-time curvature-driven geometric evolution on selected regions of a persistent cognitive manifold to stabilize reasoning trajectories and clarify admissibility boundaries. The engine operates in multiple modes including pre-traversal preconditioning, trajectory-planning coupled evolution, in-traversal stabilization, post-traversal validation, and background maintenance. Multi-scale flow sequences address coarse structural instabilities before fine-grained regularization while selectively evolving compressive components and preserving shape-preserving components to prevent semantic drift. Comprehensive failure detection monitors for pressure persistence, admissibility collapse, invariant violation, and epistemic incompatibility. When failures are detected, hallucination-safe fallback behaviors enforce output suppression, preventing fabrication or extrapolation. Repeated failure patterns trigger irreversible suppression of invalid trajectory patterns. Aggregate rate control prevents excessive cumulative evolution across reasoning sessions. The disclosed techniques reduce hallucination, improve reasoning stability, and maintain epistemic discipline in persistent cognitive systems.

According to a preferred embodiment, a computer system for reasoning in a persistent cognitive machine is disclosed, comprising a hardware memory, wherein the computer system is configured to execute software instructions stored on nontransitory machine-readable storage media that: maintain a persistent cognitive manifold comprising a structured internal state space in which proximity, connectivity, and accessibility among representations are governed by geometric structure including curvature-derived pressure fields and accessibility weights; select a region of interest within the persistent cognitive manifold based on a current reasoning task, query, or active traversal trajectory; apply a bounded-time curvature-driven geometric evolution to the selected region of interest, wherein the evolution reduces or redistributes curvature-derived pressure within the region of interest while preserving protected invariants and shape-preserving components of the cognitive manifold; evaluate one or more candidate reasoning trajectories within the evolved geometric structure to determine epistemic admissibility based on stability margins and boundary proximity; generate an admissibility certificate encoding stability features and admissibility margin measurements observed during geometric evolution when no failure condition is detected; detect one or more failure conditions within the evolved geometric structure based on stability assessment of the region of interest; select a hallucination-safe fallback behavior when a failure condition is detected, wherein the hallucination-safe fallback behavior prevents generation of fabricated or extrapolated outputs; and enforce output suppression prior to any output generation when no admissible reasoning trajectory exists.

According to a preferred embodiment, a computer-implemented method for reasoning in a persistent cognitive machine is disclosed, comprising the steps of: maintaining a persistent cognitive manifold comprising a structured internal state space in which proximity, connectivity, and accessibility among representations are governed by geometric structure including curvature-derived pressure fields and accessibility weights; selecting a region of interest within the persistent cognitive manifold based on a current reasoning task, query, or active traversal trajectory; applying a bounded-time curvature-driven geometric evolution to the selected region of interest, wherein the evolution reduces or redistributes curvature-derived pressure within the region of interest while preserving protected invariants and shape-preserving components of the cognitive manifold; evaluating one or more candidate reasoning trajectories within the evolved geometric structure to determine epistemic admissibility based on stability margins and boundary proximity; generating an admissibility certificate encoding stability features and admissibility margin measurements observed during geometric evolution when no failure condition is detected; detecting one or more failure conditions within the evolved geometric structure based on stability assessment of the region of interest; selecting a hallucination-safe fallback behavior when a failure condition is detected, wherein the hallucination-safe fallback behavior prevents generation of fabricated or extrapolated outputs; and enforcing output suppression prior to any output generation when no admissible reasoning trajectory exists.

According to an aspect of an embodiment, the failure conditions comprise at least one of: persistence or growth of curvature-derived pressure beyond predefined thresholds after bounded geometric evolution, collapse or fragmentation of admissible regions such that no continuous admissible trajectory exists, violation of protected invariants during geometric evolution, and incompatibility between the evolved geometric structure and epistemic admission constraints derived from available evidence or prior irreversible commitments.

According to an aspect of an embodiment, applying bounded-time curvature-driven geometric evolution further comprises separating geometric components of the region of interest into compressive components associated with local density, pressure, and structural congestion, and shape-preserving components associated with relational structure and topological connectivity, and wherein the evolution is applied selectively to the compressive components while the shape-preserving components are held invariant.

According to an aspect of an embodiment, applying bounded-time curvature-driven geometric evolution further comprises executing a multi-scale flow sequence in which geometric evolution is applied at a coarse scale to address large-scale curvature concentrations before applying geometric evolution at one or more finer scales, and wherein cross-scale consistency is verified following completion of the multi-scale sequence.

According to an aspect of an embodiment, the method further comprises selecting an operational mode from among a pre-traversal preconditioning mode, a trajectory-planning coupled mode, an in-traversal stabilization mode, a post-traversal validation mode, and a background maintenance mode based on task criticality, available compute budget, and manifold health indicators.

According to an aspect of an embodiment, the method includes dynamically switching the operational mode during execution when stability indicators or computational expenditure observations warrant re-selection, and enforcing aggregate rate control by applying a session-level limit on cumulative geometric evolution across multiple invocations.

According to an aspect of an embodiment, the hallucination-safe fallback behavior comprises at least one of: complete output suppression with explicit notice, a request for additional input or clarification, a switch to a lower-risk reasoning regime, generation of a qualified response encoding uncertainty, and deferral of the task for background maintenance.

According to an aspect of an embodiment, the method includes detecting a repeated failure pattern across multiple invocations associated with a common manifold region or trajectory pattern, and in response triggering irreversible suppression by projecting an abstract representation of the invalid pattern into a non-navigable reservoir to reduce future accessibility of the suppressed pattern.

According to an aspect of an embodiment, the method includes enforcing rate control by bounding the number of flow update steps, step size, and total compute budget applied to the region of interest, wherein the geometric evolution is subject to early termination upon detection of a failure condition or exhaustion of the allocated compute budget.

### BRIEF DESCRIPTION OF THE DRAWING FIGURES

FIG. 1 is a block diagram illustrating the architecture of a persistent cognitive machine platform.

FIG. 2 is a block diagram illustrating an exemplary architecture of a component within a Persistent Cognitive Machine, a language model.

FIG. 3 is a block diagram illustrating the detailed architecture of the executive core and its interactions with other components of the persistent cognitive machine platform.

FIG. 4 is a block diagram illustrating the internal architecture of a thought generator within a Persistent Cognitive Machine.

FIG. 5 is a block diagram illustrating an exemplary architecture of a component within a Persistent Cognitive Machine, a sleep manager.

FIG. 6 is a block diagram illustrating an exemplary architecture of a component within a Persistent Cognitive Machine, a persistence layer.

FIG. 7 is a block diagram illustrating an exemplary architecture of a component within a Persistent Cognitive Machine, a thought cache.

FIG. 8 is a block diagram illustrating an exemplary system architecture of a single-node implementation of a persistent cognitive machine incorporating a Ricci-flow reasoning engine, according to an embodiment.

FIG. 9 is a block diagram illustrating an exemplary system architecture of a distributed and federated implementation of a persistent cognitive machine incorporating a Ricci-flow reasoning engine, according to an embodiment.

FIG. 10 is a block diagram illustrating an exemplary system architecture of a hybrid implementation combining a persistent cognitive machine with one or more inference models, collectively forming a hybrid PCM and inference model system.

FIG. 11 is a block diagram illustrating an exemplary system architecture of a hierarchical and layered implementation of a persistent cognitive machine incorporating Ricci-flow reasoning, collectively forming a hierarchical PCM system.

FIG. 12 is a block diagram illustrating an exemplary architecture of a Ricci-flow reasoning engine, according to an embodiment.

FIG. 13 is a flow diagram illustrating an exemplary method for Ricci-flow reasoning operation within a persistent cognitive machine, according to an embodiment.

FIG. 14 is a flow diagram illustrating an exemplary method for multi-scale flow evolution with invariant preservation within a Ricci-flow reasoning engine, according to an embodiment.

FIG. 15 is a flow diagram illustrating an exemplary method for failure detection and hallucination-safe fallback within a Ricci-flow reasoning engine and the broader persistent cognitive machine, according to an embodiment.

FIG. 16 is a flow diagram illustrating an exemplary method for operational mode selection and adaptive invocation within a Ricci-flow reasoning engine, according to an embodiment.

FIG. 17 illustrates an exemplary computing environment on which an embodiment described herein may be implemented.

### DETAILED DESCRIPTION OF THE INVENTION

The inventor has conceived and reduced to practice a system and method for Ricci-flow reasoning in cognitive machines. A Ricci-flow reasoning engine performs bounded-time curvature-driven geometric evolution on selected regions of a persistent cognitive manifold to stabilize reasoning trajectories and clarify admissibility boundaries. The engine operates in multiple modes including pre-traversal preconditioning, trajectory-planning coupled evolution, in-traversal stabilization, post-traversal validation, and background maintenance. Multi-scale flow sequences address coarse structural instabilities before fine-grained regularization while selectively evolving compressive components and preserving shape-preserving components to prevent semantic drift. Comprehensive failure detection monitors for pressure persistence, admissibility collapse, invariant violation, and epistemic incompatibility. When failures are detected, hallucination-safe fallback behaviors enforce output suppression, preventing fabrication or extrapolation. Repeated failure patterns trigger irreversible suppression of invalid trajectory patterns. Aggregate rate control prevents excessive cumulative evolution across reasoning sessions. The disclosed techniques reduce hallucination, improve reasoning stability, and maintain epistemic discipline in persistent cognitive systems.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Persistent Cognitive Machine” or “PCM” refers to a computing system that maintains persistent cognitive processes regardless of external interaction, can remember previous experiences, learn from these experiences, create new thought experiences independently, and initiate interactions without waiting for external prompts. Unlike traditional AI systems that operate within a prompt-response paradigm, a PCM operates with persistent awareness even when not actively engaged with users or external systems.

As used herein, “sleep state” refers to a mode of operation in which the persistent cognitive machine temporarily reduces responsiveness to external stimuli to focus on internal cognitive maintenance processes, including but not limited to memory consolidation, thought generalization, insight generation, and memory reorganization.

As used herein, “thought” refers to a discrete unit of cognition within the persistent cognitive machine, representing information, concepts, observations, inferences, questions, or other cognitive elements that the system processes and stores. Thoughts may be derived from external inputs, generated through internal reasoning processes, or created through recombination of existing thoughts.

As used herein, “thought cache” refers to the component of the persistent cognitive machine that stores, organizes, and provides access to thoughts. The thought cache may include both short-term and long-term storage capabilities, with mechanisms for transferring information between them and organizing thoughts based on semantic relationships.

### Conceptual Architecture

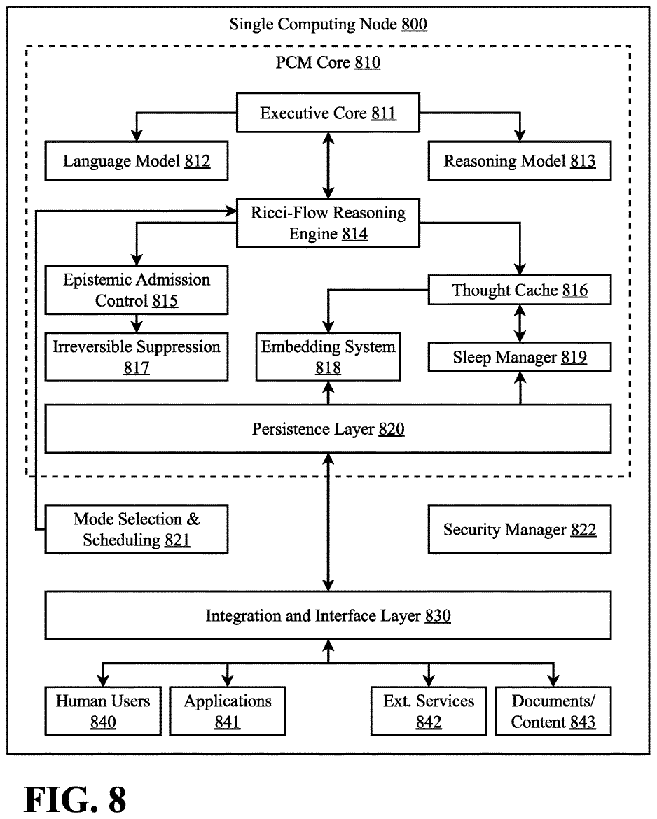

FIG. 8 is a block diagram illustrating an exemplary system architecture of a single-node implementation of a persistent cognitive machine incorporating a Ricci-flow reasoning engine, according to an embodiment. In this embodiment, all components of the persistent cognitive machine execute on a single computing node 800, which may comprise one or more processors, system memory, and non-volatile storage resources co-located within a common execution environment. The single-node architecture is suitable for consumer devices, standalone assistants, or edge deployments where latency constraints favor local reasoning and where the cognitive manifold is sized to fit within local resource budgets. Although described herein as a single node, it will be appreciated that the components and processes of this embodiment may be distributed across multiple physical or virtual computing devices without departing from the scope of the invention.

At the center of single-node implementation 800 is a PCM core 810, which encompasses the foundational cognitive components of the persistent cognitive machine platform. PCM core 810 maintains the cognitive manifold as a structured, persistent internal state space in which proximity, connectivity, and accessibility among representations are governed by geometric properties. This manifold persists across interactions and system restarts, accumulating curvature-derived structure that reflects prior commitments, accumulated experiences, and irreversible exclusions. All reasoning, memory management, and output generation operations occur within or in direct coordination with PCM core 810.

Serving as the central orchestration component of PCM core 810 is an executive core 811. Executive core 811 manages the overall cognitive processes of the system, coordinates the activities of all other components, and determines how to handle external stimuli and internal thought triggers. Executive core 811 comprises a state manager that tracks and controls operational states of the system, including active interaction states, passive observation states, independent thinking states, and sleep states; a decision coordinator that orchestrates information flow and resource allocation among system components; a thought manager that handles the retrieval and storage of thoughts within the thought cache; and a thought generator that creates new thoughts autonomously based on current cognitive processes. By maintaining awareness of system state and coordinating component interactions, executive core 811 enables the persistent cognitive machine to exhibit contextually appropriate behavior across diverse operational conditions.

Connected to executive core 811 are a language model 812 and a reasoning model 813, which together provide the generative and analytical capabilities of the persistent cognitive machine. Language model 812 provides natural language understanding and generation capabilities, processing token sequences through an input processor, a core language model, a post processor, and an output generator, with a performance monitor tracking operational metrics throughout. Reasoning model 813 extends beyond simple language processing by generating chains of thought when receiving input and using those chains of thought together with the original input to produce improved outputs. Reasoning model 813 may comprise a chain-of-thought engine, an inference layer for logical deduction, and a synthesizer for combining analysis and inference into coherent conclusions. Executive core 811 determines when to engage each of language model 812 and reasoning model 813 based on the nature of the cognitive task at hand, coordinating their operations to achieve coherent and effective output generation.

A Ricci-flow reasoning engine 814 is present and configured to perform controlled, bounded-time geometric evolution of selected regions of the cognitive manifold during reasoning operations. Ricci-flow reasoning engine 814 is invoked as part of the reasoning process rather than solely as an offline maintenance or optimization procedure, and accordingly operates as a reasoning-time operator within the cognitive architecture. In operation, Ricci-flow reasoning engine 814 selects a region of interest within the cognitive manifold based on a current task, query, goal condition, or active traversal trajectory, and applies a curvature-driven update rule to that region to evolve one or more geometric fields associated with the manifold. Such geometric fields may include, without limitation, curvature-derived pressure values, accessibility weights, and local traversal costs. The evolution performed by Ricci-flow reasoning engine 814 is subject to explicit rate control and scope control, ensuring that geometric evolution remains incremental, computationally bounded, and does not introduce instability or erase accumulated cognitive structure. The outputs of Ricci-flow reasoning engine 814 are not directly exposed as reasoning results, but instead influence subsequent trajectory computation, admissibility evaluation, and output gating. Ricci-flow reasoning engine 814 may be invoked in one or more operational modes depending on system state, task context, and applicable policy, including a pre-traversal preconditioning mode, a trajectory-planning coupled mode, an in-traversal stabilization mode, a post-traversal validation and certification mode, and a background maintenance and consolidation mode, each of which is described in further detail below.

Coupled to Ricci-flow reasoning engine 814 is an epistemic admission control component 815. Epistemic admission control component 815 evaluates candidate reasoning trajectories prior to execution based on criteria that may include available evidence, capacity constraints, and consistency with prior irreversible commitments. The Ricci-flow-regularized geometry produced by Ricci-flow reasoning engine 814 sharpens these evaluations by reducing local instability and clarifying structural boundaries within the cognitive manifold, thereby improving the reliability of admission decisions. Epistemic admission control component 815 further implements output gating mechanisms that condition generation or presentation of system outputs on the outcome of admission and monitoring processes, such that only trajectories remaining admissible under the Ricci-flow-regularized geometry are permitted to produce outputs. When no admissible trajectory exists, epistemic admission control component 815 may suppress output, request additional input, or provide an explicitly qualified response indicating uncertainty or insufficiency of evidence.

The persistent cognitive machine maintains a thought cache 816, which functions as the system's memory by storing, organizing, and providing access to thoughts across interactions and system restarts. Thought cache 816 is organized into a short-term cache that maintains recently generated or accessed thoughts in a working memory interface for rapid access during ongoing cognitive processes, and a long-term cache comprising an embedded vector store that represents thoughts as vectors in a high-dimensional abstract space and a semantic network that maintains explicit relationships among thoughts such as causality, hierarchy, and temporal sequence. Thoughts that are conceptually similar are positioned in proximity within the vector space, facilitating associative retrieval processes. A memory manager within thought cache 816 oversees the movement of thoughts between short-term and long-term storage based on factors such as thought importance, repetition, and relevance to ongoing goals. Thought cache 816 interfaces with executive core 811 to retrieve relevant thoughts based on current stimuli and to store new thoughts generated during processing, enabling the persistent cognitive machine to leverage accumulated experiences rather than responding based solely on immediate input.

An irreversible suppression mechanism 817 operates in conjunction with epistemic admission control component 815 and Ricci-flow reasoning engine 814 to prevent repeated traversal of inadmissible regions of the cognitive manifold. When monitoring mechanisms determine that a reasoning trajectory has become inadmissible, or when repeated failure of Ricci-flow reasoning occurs in similar regions or under similar task conditions, irreversible suppression mechanism 817 projects an abstract representation of the invalid pattern into a non-navigable reservoir. Such projection reduces future accessibility of the suppressed pattern and modifies the accessibility and admissibility structure of the cognitive manifold such that prohibited patterns remain representationally present but operationally inaccessible. Ricci-flow-derived diagnostics produced by Ricci-flow reasoning engine 814 may be used to identify which aspects of a failed trajectory are responsible for instability, enabling targeted suppression rather than broad exclusion.

Working in coordination with thought cache 816 is an embedding system 818, which converts thoughts into vector representations in a high-dimensional abstract space. Embedding system 818 enables efficient storage of a large volume of thoughts in a manner that positions related thoughts in proximity and unrelated thoughts at greater distances within the abstract space, thereby supporting semantic similarity-based retrieval rather than simple keyword matching. Embedding system 818 may implement various embedding technologies including, without limitation, neural network encoders, latent transformers, sentence embedding models, or hybrid approaches combining multiple embedding strategies. Embedding system 818 interfaces with both thought cache 816 and executive core 811 to facilitate effective thought organization and retrieval throughout the operation of the persistent cognitive machine.

A sleep manager 819 implements sleep-like states during which the persistent cognitive machine temporarily reduces responsiveness to external stimuli to focus on internal cognitive maintenance processes. Sleep manager 819 comprises a sleep scheduler that determines appropriate times to enter sleep states based on factors such as recent activity levels, accumulated cognitive load, and time elapsed since the last sleep cycle; a wake trigger monitor that continuously evaluates incoming stimuli against wake criteria to determine whether a stimulus is important enough to interrupt the current sleep cycle; and a thought curation processor that orchestrates the various cognitive maintenance processes occurring during sleep states, including memory consolidation, insight generation through recombination of existing thoughts, thought generalization, and memory reorganization. Sleep manager 819 interfaces with thought cache 816 in a bidirectional manner, providing the raw material for curation processes and receiving updated thought structures that result from those processes. In certain embodiments, Ricci-flow reasoning engine 814 may be invoked in a background maintenance and consolidation mode during sleep states to regularize curvature-derived structure within regions of the cognitive manifold exhibiting persistent high curvature-derived pressure, thereby preparing those regions for subsequent reasoning operations.

To ensure continuity of cognition across system shutdowns and restarts, a persistence layer 820 provides mechanisms for serializing and restoring the complete cognitive state of the persistent cognitive machine. Persistence layer 820 comprises a state serializer that converts runtime objects and data structures, including thought cache contents, relationship models, and system configurations, into formats suitable for durable storage; a snapshot generator that creates consistent point-in-time snapshots of system state at appropriate intervals; a recovery controller that manages restoration of system state upon restart; and a storage subsystem comprising primary storage optimized for rapid access, backup storage for redundancy, and a storage tiering subsystem that migrates data between storage tiers based on access patterns and aging criteria. Through persistence layer 820, the persistent cognitive machine maintains continuity of cognition despite the practical necessity of occasional system shutdowns, allowing it to resume operation with full awareness of its prior experiences, accumulated knowledge, and structural commitments.

A mode selection and scheduling subsystem 821 determines which operational mode of Ricci-flow reasoning engine 814 to invoke based on system state, task context, and applicable policy. Mode selection and scheduling subsystem 821 may consider factors including, without limitation, the criticality of the current task and tolerance for uncertainty, the time and compute budget available for the reasoning cycle, current manifold health indicators such as measured curvature and congestion levels, deployment-specific safety policies, and recent history of inadmissibility or suppression events in relevant regions. Mode selection may implement hard rules, such as requiring post-traversal validation before output generation on safety-critical tasks, and may further implement learned heuristics adapted to observed system performance. Mode selection and scheduling subsystem 821 also enforces aggregate rate control over Ricci-flow reasoning across time, preventing excessive cumulative geometric evolution and preserving long-horizon stability of the cognitive manifold.

A security manager 822 implements comprehensive security controls across the single-node implementation. Security manager 822 may include an access controller comprising authentication systems, permission management, and encryption services; an integrity monitor comprising content safety filters, audit logging, and anomaly detection; and a central policy enforcer that applies consistent security policies across the platform. These security measures protect both the platform and the sensitive cognitive state information it contains, and are particularly important in deployments involving confidential, personal, or operationally sensitive data.

An integration and interface layer 830 forms the connection between PCM core 810 and external systems or users. Integration and interface layer 830 comprises an API gateway that provides programmatic access to the platform's capabilities; user interfaces that offer direct interaction points for human users including text-based and graphical interaction mechanisms; system connectors that enable integration with external services and applications; and a document interface that provides mechanisms for ingesting and processing documents and other content into the thought cache. Integration and interface layer 830 manages data transformations, event routing, and synchronization to present a cohesive interface to external entities regardless of the specific internal component handling a given request.

The single-node implementation interacts with various external entities through integration and interface layer 830. Human users 840 may engage with the platform directly through conversational or structured interactions. Applications 841 may integrate with the platform through application programming interface (API) calls or system connectors, incorporating persistent cognitive capabilities into existing software systems. External services 842 may provide additional capabilities or information sources that the platform can access and incorporate into its cognitive processes. Documents and other content 843 provide information that the platform may ingest, analyze, and incorporate into its thought cache through the document interface.

In operation, single-node implementation 800 maintains persistent cognitive processes even when not actively engaged with external entities. When input is received through integration and interface layer 830, executive core 811 analyzes the stimulus and coordinates retrieval of relevant thoughts from thought cache 816. Ricci-flow reasoning engine 814 is invoked, under the direction of mode selection and scheduling subsystem 821, to regularize relevant regions of the cognitive manifold prior to or during trajectory selection, stabilizing reasoning and clarifying admissibility boundaries. Epistemic admission control component 815 evaluates candidate reasoning trajectories against the Ricci-flow-regularized geometry, and output gating ensures that responses are generated only for admissible trajectories. New thoughts produced during processing are encoded by embedding system 818 and stored in thought cache 816. Periodically, sleep manager 819 transitions the system into sleep states for thought curation and memory consolidation, during which Ricci-flow reasoning engine 814 may perform background maintenance operations on the cognitive manifold. Persistence layer 820 continuously serializes cognitive state to ensure that accumulated experiences, structural commitments, and relationship knowledge survive any system interruption, enabling the persistent cognitive machine to resume operation with full cognitive continuity upon restart.

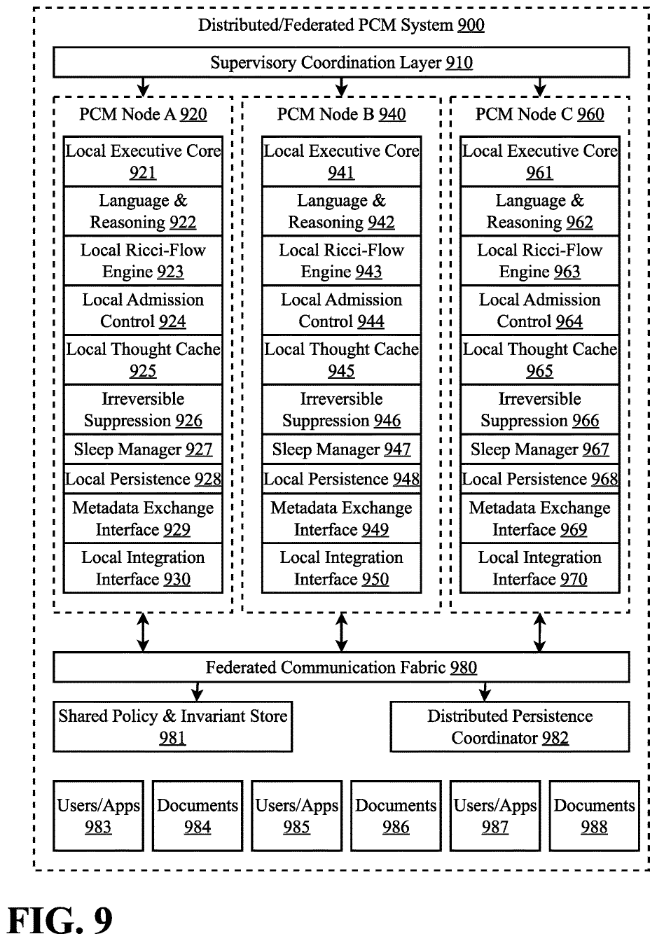

FIG. 9 is a block diagram illustrating an exemplary system architecture of a distributed and federated implementation of a persistent cognitive machine incorporating a Ricci-flow reasoning engine, according to an embodiment. In this embodiment, the persistent cognitive machine is partitioned across a plurality of computing nodes that cooperate to maintain and evolve cognitive state under shared policy constraints, collectively forming a federated PCM system 900. Each node maintains a local cognitive manifold or a local projection thereof, together with a local Ricci-flow reasoning engine operating under policies established and enforced by shared supervisory infrastructure. The distributed and federated architecture is suitable for deployments requiring scalable reasoning across large or heterogeneous knowledge domains, privacy-sensitive environments in which raw cognitive state must not be shared across organizational or jurisdictional boundaries, or applications in which fault tolerance and geographic distribution are operational requirements. Although three nodes are depicted for purposes of illustration, it will be appreciated that the federated PCM system 900 may comprise any number of cooperating nodes without departing from the scope of the invention.

At the top of federated PCM system 900 is a supervisory coordination layer 910, which spans all nodes and provides the shared governance infrastructure necessary for coherent federated operation. Supervisory coordination layer 910 comprises a shared policy engine that establishes and distributes the policies governing reasoning behavior, admissibility evaluation, and output gating across all participating nodes; a federated admission control component that coordinates cross-node admissibility determinations where reasoning trajectories implicate multiple nodes or shared knowledge domains; a global invariant registry that maintains the set of structural boundaries, protected regions, and epistemic horizon conditions that must be preserved across all nodes during Ricci-flow reasoning operations; mechanisms for cross-node stability metadata exchange that allow nodes to share admissibility summaries and stability indicators without exposing raw cognitive state; and aggregate rate control mechanisms that enforce cumulative limits on Ricci-flow evolution across the federation as a whole, preventing excessive geometric modification of the distributed cognitive manifold. Supervisory coordination layer 910 communicates with each node by transmitting policy and control signals downward and receiving stability and admissibility metadata upward, thereby enabling coordinated reasoning behavior without requiring centralized processing of cognitive content.

The federated PCM system 900 comprises a plurality of PCM nodes, illustrated as PCM node A 920, PCM node B 940, and PCM node C 960. Each node is a self-contained computing environment that independently maintains a local cognitive manifold, performs local reasoning and geometric evolution operations, enforces local admissibility constraints, and manages its own persistent cognitive state. The internal architecture of each node is substantially similar, comprising corresponding local components for executive control, language and reasoning processing, Ricci-flow reasoning, admission control, thought caching, irreversible suppression, sleep management, persistence, metadata exchange, and external integration. This structural symmetry facilitates consistent reasoning behavior and policy enforcement across the federation while permitting each node to operate autonomously within its local domain. The following paragraphs describe the internal components of PCM node A 920 in detail; corresponding components of PCM node B 940 and PCM node C 960 are structurally and functionally analogous and are identified by their respective reference numbers throughout.

Within PCM node A 920, a local executive core 921 serves as the central orchestration component responsible for managing cognitive processes within the node. Local executive core 921 comprises a state manager that tracks and controls operational states of the node, a decision coordinator that orchestrates information flow and resource allocation among local components, and a thought manager that handles retrieval and storage of thoughts within the local thought cache. Local executive core 921 operates under policies received from supervisory coordination layer 910 and coordinates with other local components to ensure that reasoning behavior within the node remains consistent with federation-wide structural commitments and invariants. Corresponding local executive cores 941 and 961 perform analogous functions within PCM node B 940 and PCM node C 960, respectively.

Each node comprises a language and reasoning component 922, which provides the generative and analytical capabilities required for cognitive processing within the node. The language and reasoning component 922 comprises a language model that provides natural language understanding and generation capabilities and a reasoning model that extends beyond simple language processing by generating chains of thought to support multi-step analytical processes. Local executive core 921 determines when to engage each of the language model and reasoning model based on the nature of the cognitive task at hand, coordinating their operations to achieve coherent outputs informed by the local cognitive manifold. Corresponding language and reasoning components 942 and 962 perform analogous functions within PCM node B 940 and PCM node C 960, respectively. In certain embodiments, the language and reasoning models instantiated at different nodes may differ in configuration, specialization, or capability to reflect differences in the knowledge domains served by each node.

A local Ricci-flow reasoning engine 923 is instantiated within PCM node A 920 and performs controlled, bounded-time geometric evolution of selected regions of the local cognitive manifold during reasoning operations. Local Ricci-flow reasoning engine 923 applies curvature-driven update rules to locally selected regions of interest, evolving geometric fields such as curvature-derived pressure values, accessibility weights, and local traversal costs to regularize the cognitive manifold prior to or during reasoning traversal. The evolution performed by local Ricci-flow reasoning engine 923 is subject to explicit local rate control and scope control, ensuring that geometric evolution remains incremental and computationally bounded within the node. Local Ricci-flow reasoning engine 923 operates under constraints derived from the global invariant registry maintained by supervisory coordination layer 910, which defines structural boundaries and protected regions that must be preserved across flow operations to maintain federation-wide consistency. In certain embodiments, local Ricci-flow reasoning engine 923 may be invoked in any of the operational modes described herein, including pre-traversal preconditioning, trajectory-planning coupled operation, in-traversal stabilization, post-traversal validation and certification, and background maintenance and consolidation, subject to the aggregate rate control policies enforced by supervisory coordination layer 910. Corresponding local Ricci-flow reasoning engines 943 and 963 perform analogous operations within PCM node B 940 and PCM node C 960, respectively.

A local admission control component 924 evaluates candidate reasoning trajectories within PCM node A 920 prior to execution and implements output gating to ensure that only admissible trajectories produce outputs. Local admission control component 924 receives the evolved geometric fields produced by local Ricci-flow reasoning engine 923 and uses the regularized manifold geometry to sharpen admissibility evaluations by reducing local instability and clarifying structural boundaries within the local cognitive manifold. Where a reasoning task implicates knowledge domains residing on other nodes, local admission control component 924 may coordinate with federated admission control mechanisms within supervisory coordination layer 910 to obtain cross-node admissibility determinations without requiring transfer of raw cognitive state between nodes. When no admissible trajectory exists within the local manifold, local admission control component 924 may suppress output, request additional input, generate a qualified response, or defer the task pending further information or background maintenance. Corresponding local admission control components 944 and 964 perform analogous functions within PCM node B 940 and PCM node C 960, respectively.

Each node maintains a local thought cache 925, which stores a local projection of the cognitive manifold together with an embedding system for representing thoughts as vectors in a high-dimensional abstract space. Local thought cache 925 organizes thoughts in both short-term and long-term storage structures, enabling rapid access to recently generated thoughts during active cognitive processes and persistent retention of accumulated experiences across interactions and system restarts. The local manifold projection maintained by local thought cache 925 reflects the subset of the overall federated cognitive manifold that is local to PCM node A 920, including the curvature-derived structure accumulated through prior Ricci-flow reasoning operations, irreversible suppression events, and memory consolidation processes specific to the node's knowledge domain. Raw cognitive state stored within local thought cache 925 is not transmitted to other nodes; only higher-level stability indicators and admissibility metadata derived from that state are shared through the federated communication infrastructure. Corresponding local thought caches 945 and 965 perform analogous functions within PCM node B 940 and PCM node C 960, respectively.

An irreversible suppression component 926 operates within each node to prevent repeated traversal of inadmissible regions of the local cognitive manifold. When local admission control component 924 or local Ricci-flow reasoning engine 923 determines that a reasoning trajectory or pattern is inadmissible, irreversible suppression component 926 projects an abstract representation of the invalid pattern into a non-navigable reservoir, reducing future accessibility of the suppressed pattern within the local manifold. A sleep manager 927 operates in parallel within the node, implementing sleep-like states during which the node temporarily reduces responsiveness to external stimuli to focus on internal cognitive maintenance. During sleep states, sleep manager 927 oversees memory consolidation, insight generation through recombination of existing thoughts, thought generalization, and memory reorganization within the local thought cache 925. In certain embodiments, local Ricci-flow reasoning engine 923 may be invoked in a background maintenance and consolidation mode during sleep states to regularize curvature-derived structure within regions of the local manifold exhibiting persistent high curvature-derived pressure. Corresponding irreversible suppression components 946 and 966 and sleep managers 947 and 967 perform analogous functions within PCM node B 940 and PCM node C 960, respectively.

A local persistence layer 928 provides mechanisms for serializing and restoring the local cognitive state of PCM node A 920 across system shutdowns and restarts. Local persistence layer 928 comprises a local state serializer, a snapshot generator, and a recovery controller that together ensure continuity of the local cognitive manifold, accumulated thought structures, and relationship knowledge specific to the node's domain. Local persistence layer 928 operates in coordination with distributed persistence coordinator 982, described further below, which manages cross-node snapshot coordination, federated recovery procedures, and state versioning to ensure coherent restoration of the federated cognitive system following interruptions affecting one or more nodes. Corresponding local persistence layers 948 and 968 perform analogous functions within PCM node B 940 and PCM node C 960, respectively.

A metadata exchange interface 929 provides the boundary through which PCM node A 920 participates in federated coordination without exposing raw cognitive state to other nodes. Metadata exchange interface 929 generates and transmits outbound metadata comprising stability indicators derived from the outputs of local Ricci-flow reasoning engine 923, admissibility summaries derived from local admission control component 924, and suppression event notifications generated by irreversible suppression component 926. Metadata exchange interface 929 also receives inbound metadata from other nodes via federated communication fabric 980 and from supervisory coordination layer 910, which may include updated policy parameters, global invariant updates, and aggregated stability information relevant to the local node's reasoning operations. By restricting inter-node communication to derived metadata rather than raw cognitive representations, metadata exchange interface 929 preserves the privacy of each node's local cognitive content while still enabling coherent coordination across the federation. Corresponding metadata exchange interfaces 949 and 969 perform analogous functions within PCM node B 940 and PCM node C 960, respectively.

A local integration interface 930 provides the connection between PCM node A 920 and the external entities within its domain. Local integration interface 930 comprises an API gateway that provides programmatic access to the node's cognitive capabilities, user interface components that enable direct interaction by human users, and system connectors that facilitate integration with external services and applications. Through local integration interface 930, users and applications within the domain of PCM node A 920 may submit queries, receive responses, and share documents for ingestion into the local thought cache 925, all without requiring direct access to the cognitive infrastructure of other nodes. Corresponding local integration interfaces 950 and 970 perform analogous functions within PCM node B 940 and PCM node C 960, respectively.

A federated communication fabric 980 provides the inter-node messaging infrastructure through which participating nodes exchange metadata and coordinate reasoning behavior. Federated communication fabric 980 implements inter-node messaging protocols, policy synchronization mechanisms, and privacy-preserving metadata routing that together enable coherent federated operation without requiring transmission of raw cognitive state between nodes. Federated communication fabric 980 connects each node's metadata exchange interface to the supervisory coordination layer 910, to the shared policy and invariant store 981, and to the distributed persistence coordinator 982. In certain embodiments, federated communication fabric 980 may implement encryption, access controls, and audit logging appropriate to the sensitivity of the metadata being exchanged, particularly in deployments involving classified, regulated, or otherwise sensitive information.

A shared policy and invariant store 981 maintains the federation-wide structural constraints that govern Ricci-flow reasoning operations across all nodes. Shared policy and invariant store 981 stores structural boundaries derived from prior irreversible commitments across the federation, protected regions designated by supervisory control that must not be modified by local flow operations, and epistemic horizon conditions that define the outer limits of admissible reasoning within the federated system. Local Ricci-flow reasoning engines 923, 943, and 963 incorporate constraints from shared policy and invariant store 981 as boundary conditions, penalty terms, or normalization factors during geometric evolution, ensuring that local flow operations preserve global structural integrity. By centralizing invariant management in shared policy and invariant store 981, the federated system ensures continuity of interpretation and prevents semantic drift arising from independent local flow operations that might otherwise produce inconsistent structural outcomes across nodes.

A distributed persistence coordinator 982 manages cross-node aspects of cognitive state preservation and recovery within federated PCM system 900. Distributed persistence coordinator 982 coordinates the timing and sequencing of snapshots across local persistence layers 928, 948, and 968 to ensure that consistent, federation-wide recovery points are available. In the event of a failure affecting one or more nodes, distributed persistence coordinator 982 orchestrates federated recovery procedures that restore the affected nodes to a state consistent with the most recent valid cross-node snapshot, preserving the structural commitments and accumulated knowledge of the federation as a whole. Distributed persistence coordinator 982 also manages state versioning to support orderly evolution of the federated cognitive manifold over time, enabling nodes to be updated, replaced, or added to the federation without loss of accumulated cognitive continuity.

Each node serves a distinct domain of external entities. Users and applications within the domain of PCM node A 920 interact with the federation through local integration interface 930, as represented by external entities 983 and 984. Users and applications within the domain of PCM node B 940 interact through local integration interface 950, as represented by external entities 985 and 986. Users and applications within the domain of PCM node C 960 interact through local integration interface 970, as represented by external entities 987 and 988. Each domain may correspond to a distinct organizational unit, geographic region, security classification level, or knowledge specialization, with domain-specific users and documents remaining local to their respective nodes. The federated architecture thereby enables each domain to benefit from locally scoped cognitive capabilities while also participating in the broader federated system through privacy-preserving metadata exchange.

In operation, federated PCM system 900 processes inputs received at any node through that node's local integration interface, applies local Ricci-flow reasoning under policies distributed by supervisory coordination layer 910 and constraints maintained in shared policy and invariant store 981, evaluates candidate reasoning trajectories through local admission control, and generates outputs only for admissible trajectories as determined under the Ricci-flow-regularized local manifold geometry. Metadata summarizing local stability conditions and admissibility outcomes is exchanged among nodes via federated communication fabric 980 and supervisory coordination layer 910, enabling the federation to maintain coherent reasoning behavior across nodes without exposing raw cognitive state. Periodic sleep states within each node support local thought curation and memory consolidation, with background Ricci-flow maintenance operations improving long-horizon manifold health. Distributed persistence coordinator 982 ensures that the cognitive state of the entire federation is preserved across any interruption, enabling the federated PCM system to resume operation with full cognitive continuity upon recovery. Through these mechanisms, federated PCM system 900 achieves the persistent cognitive capabilities of the underlying architecture at scale, across distributed and potentially heterogeneous computing environments, while preserving the privacy, structural integrity, and epistemic discipline required by complex real-world deployments.

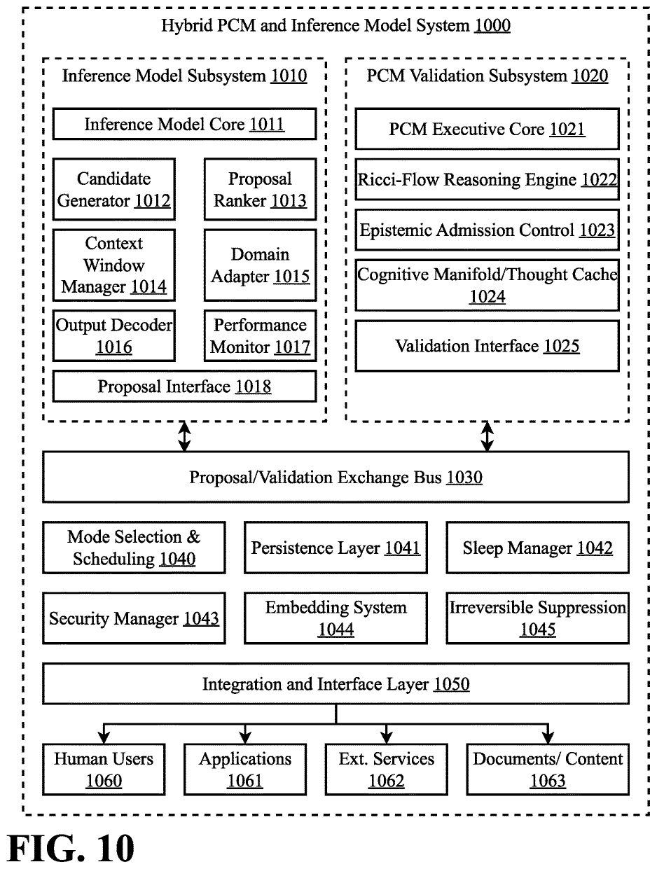

FIG. 10 is a block diagram illustrating an exemplary system architecture of a hybrid implementation combining a persistent cognitive machine with one or more inference models, collectively forming a hybrid PCM and inference model system 1000. In this embodiment, the persistent cognitive machine and one or more inference models operate as distinct but coordinated subsystems, wherein the inference model proposes candidate reasoning trajectories or response outputs and the persistent cognitive machine determines whether such proposals are admissible within the cognitive manifold before permitting decoding or presentation of outputs. This separation of proposal generation from epistemic validation enables existing inference models to be reused or substituted without granting them authority to bypass the structural constraints enforced by the persistent cognitive machine. The hybrid architecture is particularly suited to deployments in which high-throughput generative capabilities are desired alongside rigorous hallucination suppression and epistemic discipline, and to applications in which the inference model may be updated, replaced, or specialized without modifying the underlying cognitive manifold or its accumulated structural commitments.

Hybrid PCM and inference model system 1000 comprises two primary subsystems. An inference model subsystem 1010 provides the generative and analytical capabilities responsible for producing candidate reasoning trajectories and response proposals. A PCM validation subsystem 1020 provides the persistent cognitive architecture responsible for evaluating the structural and epistemic admissibility of those proposals and for gating outputs accordingly. Inference model subsystem 1010 and PCM validation subsystem 1020 are coupled through a proposal and validation exchange bus 1030, described further below, which provides the structured communication channel through which candidate proposals flow from inference model subsystem 1010 to PCM validation subsystem 1020 and admissibility decisions, revision instructions, and suppression notifications flow in return.

In inference model subsystem 1010 is an inference model core 1011, which implements the neural network architecture responsible for generative language processing and reasoning. Inference model core 1011 may comprise a language model providing natural language understanding and generation capabilities, a reasoning model providing chain-of-thought and multi-step analytical capabilities, and a generative backbone that processes input prompts and produces candidate outputs. Inference model core 1011 may be implemented using any suitable generative architecture and may be independently updated, fine-tuned, or replaced without modifying the persistent cognitive manifold or the structural commitments maintained by PCM validation subsystem 1020. In certain embodiments, multiple inference model cores may be instantiated within inference model subsystem 1010, each specialized for different task types or domains, with candidate generator 1012 selecting among them based on task context.

A candidate generator 1012 operates within inference model subsystem 1010 to produce one or more candidate reasoning trajectories or response proposals based on the current input and the outputs of inference model core 1011. Candidate generator 1012 may employ various sampling, beam search, or other decoding strategies to generate a diverse set of candidate proposals that represent different potential responses or reasoning paths for a given input. A proposal ranker 1013 evaluates and scores the candidate proposals produced by candidate generator 1012 based on criteria such as coherence, relevance, confidence, and consistency with available context. Proposal ranker 1013 orders candidates to prioritize those most likely to be found admissible by PCM validation subsystem 1020, thereby improving the efficiency of the proposal and validation cycle by submitting higher-quality candidates for epistemic evaluation first.

A context window manager 1014 manages the input context provided to inference model core 1011, ensuring that appropriate context is maintained when processing longer sequences, ongoing conversations, or complex multi-part queries. Context window manager 1014 may incorporate context derived from external inputs as well as contextual information returned from PCM validation subsystem 1020 following prior proposal and validation cycles, enabling the inference model to refine subsequent proposals in light of prior admissibility evaluations. A domain adapter 1015 manages task-specific configurations of inference model core 1011, adjusting operational parameters, prompt formatting, and specialized processing to optimize inference model behavior for particular domains, task types, or user contexts. Domain adapter 1015 may dynamically reconfigure inference model core 1011 in response to feedback received from PCM validation subsystem 1020, for example by adjusting sampling parameters or prompt structure when prior proposals have been found inadmissible.

An output decoder 1016 prepares candidate proposals from candidate generator 1012 for submission to PCM validation subsystem 1020 through proposal interface 1018. Output decoder 1016 performs detokenization, response formatting, and structural preparation of candidate proposals such that they are expressed in a form suitable for admissibility evaluation against the cognitive manifold. It will be appreciated that output decoder 1016 does not finalize outputs for presentation to external entities; final output generation is conditioned on the admissibility determination returned by PCM validation subsystem 1020 through proposal and validation exchange bus 1030. A performance monitor 1017 tracks operational metrics of inference model subsystem 1010, including processing latency, token consumption, candidate quality distributions, and admissibility rates across proposal cycles. Performance monitor 1017 provides feedback to domain adapter 1015 and candidate generator 1012 to enable dynamic optimization of inference model behavior over time.

A proposal interface 1018 forms the boundary through which inference model subsystem 1010 communicates with proposal and validation exchange bus 1030. Proposal interface 1018 submits candidate trajectories and response proposals formatted by output decoder 1016 to exchange bus 1030 for transmission to PCM validation subsystem 1020. Proposal interface 1018 also receives admissibility decisions, revision instructions, and suppression notifications returned by PCM validation subsystem 1020 through exchange bus 1030, and routes this information to the appropriate components within inference model subsystem 1010 for incorporation into subsequent proposal cycles. Through proposal interface 1018, inference model subsystem 1010 participates in an iterative proposal and validation cycle while remaining structurally separated from the epistemic validation machinery of PCM validation subsystem 1020.

Within PCM validation subsystem 1020, a PCM executive core 1021 serves as the central orchestration component responsible for managing the cognitive processes of the persistent cognitive machine. PCM executive core 1021 comprises a state manager that tracks and controls the operational states of the persistent cognitive machine, a decision coordinator that determines appropriate actions and resource allocations in response to incoming candidate proposals and current cognitive state, and a thought manager that handles retrieval and storage of thoughts within the cognitive manifold and thought cache 1024. PCM executive core 1021 coordinates the activities of all other components within PCM validation subsystem 1020, determines when to invoke Ricci-flow reasoning engine 1022, and oversees the overall admissibility evaluation process for each candidate proposal received from inference model subsystem 1010.

A Ricci-flow reasoning engine 1022 is instantiated within PCM validation subsystem 1020 and performs controlled, bounded-time geometric evolution of selected regions of the cognitive manifold in connection with the evaluation of candidate proposals received from inference model subsystem 1010. Upon receipt of a candidate proposal, Ricci-flow reasoning engine 1022 selects one or more regions of interest within the cognitive manifold relevant to the candidate trajectory and applies curvature-driven update rules to evolve the geometric fields associated with those regions, including curvature-derived pressure values, accessibility weights, and local traversal costs. The regularized manifold geometry produced by this evolution is used to sharpen admissibility evaluations, stabilize reasoning trajectories, and clarify structural boundaries prior to the determination of whether the candidate proposal may proceed to output. Ricci-flow reasoning engine 1022 generates flow diagnostics and, in certain embodiments, admissibility certificates that capture geometric and diagnostic features observed during flow evolution, providing an auditable record of the admissibility evaluation process. Ricci-flow reasoning engine 1022 may be invoked in one or more operational modes depending on the nature of the candidate proposal and applicable policy, and is subject to explicit rate control and scope control to ensure that geometric evolution remains computationally bounded and does not compromise the accumulated structural integrity of the cognitive manifold.

An epistemic admission control component 1023 evaluates candidate proposals from inference model subsystem 1010 against the Ricci-flow-regularized cognitive manifold geometry produced by Ricci-flow reasoning engine 1022. Epistemic admission control component 1023 performs pre-admission evaluation of candidate trajectories based on criteria that may include available evidence, capacity constraints, and consistency with prior irreversible commitments encoded in cognitive manifold and thought cache 1024. During traversal of an admitted trajectory, epistemic admission control component 1023 monitors the evolution of cognitive state to detect deviations from admissible regions, onset of excessive curvature, or other indicators of epistemic failure. Epistemic admission control component 1023 verifies admissibility certificates generated by Ricci-flow reasoning engine 1022 and implements output gating that conditions generation or presentation of responses on the outcome of admission and monitoring processes. Only candidate proposals that satisfy admissibility requirements under the Ricci-flow-regularized geometry are permitted to produce outputs; proposals that fail admission evaluation are returned to inference model subsystem 1010 through validation interface 1025 and exchange bus 1030 with revision instructions that may inform the generation of revised proposals.

A cognitive manifold and thought cache 1024 maintains the persistent internal state of the persistent cognitive machine, comprising the structured geometric space within which reasoning traversal occurs and the accumulated thought representations that encode the system's cognitive history. Cognitive manifold and thought cache 1024 stores the persistent manifold state including curvature-derived geometric fields that reflect accumulated structural commitments and prior Ricci-flow evolution operations; a vector store comprising embedded vector representations of thoughts organized by semantic similarity; a semantic network maintaining explicit relationships among thoughts such as causality, hierarchy, and temporal sequence; and an irreversible suppression reservoir into which abstract representations of invalid trajectory patterns are projected by irreversible suppression component 1045. The persistent manifold state maintained in cognitive manifold and thought cache 1024 accumulates over time as the system processes candidate proposals, consolidates memories during sleep states, and incorporates feedback from admissibility evaluations, developing an increasingly rich and geometrically structured cognitive substrate that reflects the system's accumulated experience and structural commitments. Embedding system 1044 encodes newly generated thoughts into vector representations for storage in cognitive manifold and thought cache 1024, supporting efficient semantic similarity-based retrieval during subsequent reasoning operations.

A validation interface 1025 forms the boundary through which PCM validation subsystem 1020 communicates with proposal and validation exchange bus 1030. Validation interface 1025 receives candidate trajectory submissions from exchange bus 1030 and routes them to PCM executive core 1021 for processing. Validation interface 1025 transmits admissibility decisions back through exchange bus 1030 to inference model subsystem 1010, indicating whether each candidate proposal has been found admissible and may proceed to output, or has been rejected and requires revision. Where a proposal is rejected, validation interface 1025 generates and transmits revision instructions derived from the outputs of Ricci-flow reasoning engine 1022 and epistemic admission control component 1023, which may include information about the nature of the admissibility failure and guidance for generating revised proposals more likely to satisfy structural constraints. Validation interface 1025 also transmits suppression notifications when irreversible suppression component 1045 has recorded a pattern as non-navigable, informing inference model subsystem 1010 that similar proposals should be avoided in subsequent cycles.

A proposal and validation exchange bus 1030 provides the structured communication channel coupling inference model subsystem 1010 and PCM validation subsystem 1020. Proposal and validation exchange bus 1030 carries candidate trajectory submissions from proposal interface 1018 to validation interface 1025, and returns admissibility decisions, revision instructions, and suppression notifications from validation interface 1025 to proposal interface 1018. Through proposal and validation exchange bus 1030, the proposal and validation cycle may proceed iteratively, with inference model subsystem 1010 generating revised proposals in response to rejection feedback until an admissible proposal is identified or a fallback behavior is triggered. Proposal and validation exchange bus 1030 also provides connectivity to the shared supporting infrastructure components described below, including mode selection and scheduling subsystem 1040, persistence layer 1041, and sleep manager 1042.

A mode selection and scheduling subsystem 1040 determines which operational mode of Ricci-flow reasoning engine 1022 to invoke in connection with each candidate proposal received from inference model subsystem 1010. Mode selection and scheduling subsystem 1040 may select among a pre-traversal preconditioning mode invoked prior to trajectory selection, a trajectory-planning coupled mode in which flow evolution and trajectory computation are interleaved, an in-traversal stabilization mode invoked dynamically during traversal when instability is detected, a post-traversal validation and certification mode invoked after candidate trajectory completion to validate robust admissibility prior to output, and a background maintenance and consolidation mode applied during off-task periods. Mode selection and scheduling subsystem 1040 considers factors including task criticality, available compute budget, current manifold health indicators, and applicable deployment policy, and enforces aggregate rate control over Ricci-flow reasoning to prevent excessive cumulative geometric evolution.

A persistence layer 1041 provides mechanisms for serializing and restoring the cognitive state of PCM validation subsystem 1020 across system shutdowns and restarts. Persistence layer 1041 comprises a state serializer that converts the contents of cognitive manifold and thought cache 1024, relationship models, and system configurations into formats suitable for durable storage; a snapshot generator that creates consistent point-in-time snapshots of the cognitive state at appropriate intervals; and a recovery controller that manages restoration of cognitive state upon restart. Through persistence layer 1041, the accumulated structural commitments, curvature-derived fields, and thought representations of the persistent cognitive machine survive system interruptions, enabling hybrid PCM and inference model system 1000 to resume operation with full cognitive continuity. It will be appreciated that while persistence layer 1041 preserves the cognitive state of PCM validation subsystem 1020 across restarts, the inference model weights and configurations of inference model subsystem 1010 may be managed through separate mechanisms appropriate to the specific inference model implementation.

A sleep manager 1042 implements sleep-like states during which the persistent cognitive machine temporarily reduces responsiveness to new candidate proposals from inference model subsystem 1010 to focus on internal cognitive maintenance, including memory consolidation, insight generation, thought generalization, and memory reorganization within cognitive manifold and thought cache 1024. During sleep states, Ricci-flow reasoning engine 1022 may be invoked in background maintenance and consolidation mode to regularize curvature-derived structure within regions of the cognitive manifold exhibiting persistent high pressure. A security manager 1043 implements access control, integrity monitoring, and policy enforcement across hybrid PCM and inference model system 1000, ensuring that neither inference model subsystem 1010 nor external entities may directly modify the cognitive manifold state or bypass the output gating mechanisms of epistemic admission control component 1023. An embedding system 1044 converts new thoughts generated during the processing of admitted proposals into vector representations for storage in cognitive manifold and thought cache 1024. An irreversible suppression component 1045 records invalid trajectory patterns in the non-navigable reservoir of cognitive manifold and thought cache 1024 and generates suppression notifications transmitted to inference model subsystem 1010 through validation interface 1025 and exchange bus 1030.

An integration and interface layer 1050 forms the connection between hybrid PCM and inference model system 1000 and external entities. Integration and interface layer 1050 comprises an API gateway providing programmatic access to system capabilities, user interface components enabling direct interaction by human users, system connectors facilitating integration with external services and applications, and a document interface providing mechanisms for ingesting content into the cognitive manifold and thought cache 1024. Human users 1060 may engage with the system through direct interaction. Applications 1061 may integrate with the system through API calls. External services 1062 may provide additional capabilities or information sources accessible through system connectors. Documents and other content 1063 may be ingested through the document interface and incorporated into the cognitive manifold and thought cache 1024, enriching the persistent knowledge available to PCM validation subsystem 1020 during admissibility evaluation.

In operation, hybrid PCM and inference model system 1000 processes incoming inputs received through integration and interface layer 1050 by routing them to inference model subsystem 1010, which generates one or more candidate reasoning trajectories or response proposals through inference model core 1011, candidate generator 1012, and proposal ranker 1013. These proposals are submitted to PCM validation subsystem 1020 through proposal interface 1018 and exchange bus 1030. PCM executive core 1021 receives the proposals and, under the direction of mode selection and scheduling subsystem 1040, invokes Ricci-flow reasoning engine 1022 to regularize relevant regions of the cognitive manifold and assess the stability of candidate trajectories. Epistemic admission control component 1023 evaluates each proposal against the Ricci-flow-regularized manifold geometry and returns an admissibility determination through validation interface 1025 and exchange bus 1030. Admitted proposals proceed to output decoding and presentation through integration and interface layer 1050; rejected proposals trigger revision instructions transmitted back to inference model subsystem 1010 for incorporation into revised proposals. New thoughts generated during processing of admitted proposals are encoded by embedding system 1044 and stored in cognitive manifold and thought cache 1024, continuously enriching the persistent cognitive substrate that governs future admissibility evaluations. Persistence layer 1041 ensures that the accumulated cognitive state of PCM validation subsystem 1020 survives any system interruption, and sleep manager 1042 periodically consolidates and reorganizes the cognitive manifold to maintain long-horizon stability and reasoning effectiveness.

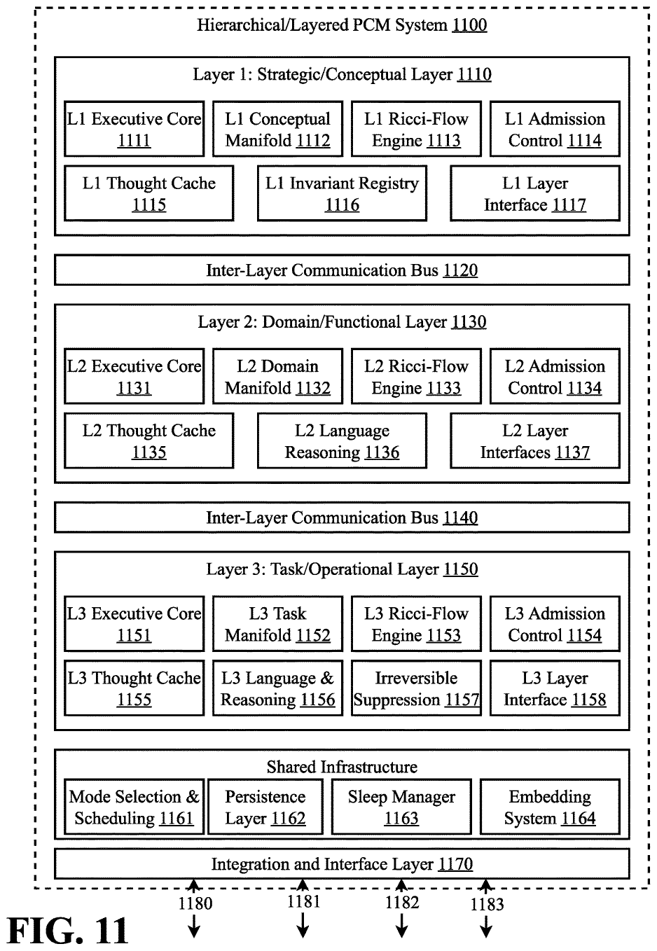

FIG. 11 is a block diagram illustrating an exemplary system architecture of a hierarchical and layered implementation of a persistent cognitive machine incorporating Ricci-flow reasoning, collectively forming a hierarchical PCM system 1100. In this embodiment, the cognitive manifold and its associated reasoning, admission control, and memory management components are organized into a plurality of distinct layers corresponding to different levels of abstraction, timescale, and functional role. Each layer maintains its own cognitive manifold, Ricci-flow reasoning engine, admission control component, and thought cache, with Ricci-flow reasoning applied selectively at each layer according to the spatial scale and temporal frequency appropriate to that layer's function. Constraints and invariants propagate downward from higher layers to lower layers through inter-layer communication buses, while diagnostic information and admissibility summaries aggregate upward. Output generation is conditioned on admissibility at all relevant layers, such that a failure of admissibility at any layer prevents output regardless of the admissibility determination at other layers. The hierarchical architecture is particularly suited to complex, long-lived cognitive systems requiring simultaneous management of strategic long-horizon coherence, domain-specific functional consistency, and fine-grained task-level stability, as well as to deployments in which instability at one layer must be prevented from propagating uncontrollably to others.

Hierarchical PCM system 1100 comprises various (e.g., three exemplary layers are shown, but more or fewer layers may be implemented according to the embodiment) cognitive layers arranged in a vertical hierarchy. A strategic and conceptual layer 1110 occupies the highest position in the hierarchy and is responsible for maintaining long-horizon coherence of the cognitive manifold through infrequent, coarse-scale Ricci-flow operations. A domain and functional layer 1130 occupies the middle position and is responsible for maintaining domain-specific consistency and functional stability through moderate-frequency, mid-scale Ricci-flow operations. A task and operational layer 1150 occupies the lowest position and is responsible for active task-level reasoning stability through frequent, fine-grained Ricci-flow operations applied to regions of the cognitive manifold directly engaged in current task processing. Strategic and conceptual layer 1110 and domain and functional layer 1130 are coupled through a first inter-layer communication bus 1120, and domain and functional layer 1130 and task and operational layer 1150 are coupled through a second inter-layer communication bus 1140. Shared infrastructure components and an integration and interface layer serving all three cognitive layers are described further below.

Within strategic and conceptual layer 1110, an L1 executive core 1111 serves as the central orchestration component of the highest layer of the hierarchy. L1 executive core 1111 manages the long-horizon cognitive state of the system, coordinates the activities of all components within strategic and conceptual layer 1110, and performs cross-layer coordination by establishing the strategic constraints and invariants that govern the behavior of lower layers. L1 executive core 1111 operates on timescales appropriate to long-horizon strategic cognition, responding to accumulated patterns and structural trends in the cognitive manifold rather than to individual task-level stimuli. In certain embodiments, L1 executive core 1111 may initiate updates to the invariant registry 1116 and propagate revised constraints downward through inter-layer communication bus 1120 in response to significant structural changes detected in the cognitive manifold at the strategic level.

An L1 conceptual manifold 1112 maintains the highest-level regions of the cognitive manifold, comprising abstract conceptual representations, long-term structural commitments, and high-level relational structures that persist across extended operational periods and multiple task cycles. The geometric structure of L1 conceptual manifold 1112 reflects accumulated curvature-derived pressure arising from the system's long-term cognitive history and irreversible commitments, and defines the broadest admissibility boundaries within which lower-layer reasoning must remain. An L1 Ricci-flow reasoning engine 1113 performs coarse-scale, infrequently applied geometric evolution of selected regions of L1 conceptual manifold 1112. L1 Ricci-flow reasoning engine 1113 addresses large-scale curvature concentrations and structural congestion within the highest-level regions of the cognitive manifold that could otherwise bias or destabilize reasoning across all layers of the hierarchy. Because the effects of coarse-scale flow at the strategic layer propagate downward as modified constraints and admissibility boundaries, L1 Ricci-flow reasoning engine 1113 is invoked with particular care and is subject to conservative rate control and scope control to prevent unintended modification of long-term structural commitments. In certain embodiments, L1 Ricci-flow reasoning engine 1113 is invoked primarily in background maintenance and consolidation mode during scheduled maintenance windows rather than in direct response to individual task requests.

An L1 admission control component 1114 evaluates the strategic admissibility of reasoning trajectories within strategic and conceptual layer 1110 and implements cross-layer output gating that conditions the generation of outputs on strategic-level admissibility. L1 admission control component 1114 receives the evolved geometric fields produced by L1 Ricci-flow reasoning engine 1113 and uses the regularized manifold geometry to evaluate whether candidate reasoning trajectories are consistent with long-term structural commitments and strategic epistemic horizons. An L1 thought cache 1115 stores abstract concept representations and long-term invariant thought structures that persist across extended operational periods, providing the accumulated strategic knowledge base that informs L1 admission control component 1114 during admissibility evaluation. An L1 invariant registry 1116 maintains the set of protected regions, epistemic horizon conditions, and structural boundary conditions that must be preserved across all flow operations within hierarchical PCM system 1100. L1 invariant registry 1116 is the authoritative source of invariant constraints for the entire hierarchy; constraints derived from L1 invariant registry 1116 are propagated downward to domain and functional layer 1130 and task and operational layer 1150 through the inter-layer communication buses, ensuring consistent enforcement of the highest-level structural boundaries throughout the system.

An L1 layer interface 1117 provides the downward-facing boundary through which strategic and conceptual layer 1110 communicates with lower layers. L1 layer interface 1117 generates and transmits constraint propagation signals derived from L1 invariant registry 1116, distributes updated invariant conditions to lower layers, and coordinates admissibility determinations with domain and functional layer 1130 when cross-layer reasoning trajectories require strategic-level evaluation. L1 layer interface 1117 also receives diagnostic aggregation signals from lower layers, providing L1 executive core 1111 with visibility into instability conditions, admissibility failures, and suppression events occurring at lower levels of the hierarchy. A first inter-layer communication bus 1120 couples strategic and conceptual layer 1110 and domain and functional layer 1130, carrying constraint propagation signals, admissibility coordination information, and diagnostic aggregation between the two layers. Inter-layer communication bus 1120 does not carry raw cognitive state between layers; only derived constraint parameters, admissibility metadata, and diagnostic summaries are transmitted, preserving the structural integrity of each layer's local manifold.

Domain and functional layer 1130 occupies the middle position of the hierarchy and is responsible for maintaining domain-specific functional consistency across the knowledge areas served by hierarchical PCM system 1100. An L2 executive core 1131 manages the domain-level cognitive state, coordinates the components of domain and functional layer 1130, and mediates the relationship between the strategic constraints received from strategic and conceptual layer 1110 and the task-level operations conducted by task and operational layer 1150. An L2 domain manifold 1132 maintains domain-specific regions of the cognitive manifold, comprising representations organized around particular knowledge domains, functional roles, or application areas, together with the mid-term structural state accumulated through domain-level cognitive operations. An L2 Ricci-flow reasoning engine 1133 performs mid-scale, moderately frequent geometric evolution of selected regions of L2 domain manifold 1132, addressing domain-level curvature concentrations and structural instabilities that arise from accumulated domain-specific cognitive activity. L2 Ricci-flow reasoning engine 1133 operates within the constraint boundaries propagated from strategic and conceptual layer 1110 through inter-layer communication bus 1120, ensuring that domain-level flow operations do not violate the invariants and protected regions defined at the strategic level.

An L2 admission control component 1134 evaluates the domain-level admissibility of reasoning trajectories within domain and functional layer 1130. L2 admission control component 1134 enforces the requirement that candidate trajectories satisfy admissibility conditions at multiple layers simultaneously; a trajectory admitted at the domain level must still satisfy the admissibility requirements of strategic and conceptual layer 1110 before output is permitted. An L2 thought cache 1135 maintains domain knowledge representations and mid-term thought structures, providing the accumulated domain-specific knowledge base that informs both L2 admission control component 1134 and the language and reasoning capabilities of domain and functional layer 1130. An L2 language and reasoning component 1136 provides domain-adapted generative and analytical capabilities within domain and functional layer 1130, comprising a domain-adapted language model and a reasoning model configured to operate effectively within the knowledge domains served by this layer. In certain embodiments, L2 language and reasoning component 1136 may be configured differently from the language and reasoning components of task and operational layer 1150 to reflect the different abstraction level and cognitive function of the domain layer.

An L2 layer interface 1137 provides both upward-facing and downward-facing boundaries through which domain and functional layer 1130 communicates with adjacent layers. In the upward direction, L2 layer interface 1137 transmits diagnostic reports and admissibility summaries to strategic and conceptual layer 1110 through inter-layer communication bus 1120, providing L1 executive core 1111 with visibility into domain-level instability conditions and structural trends. In the downward direction, L2 layer interface 1137 receives constraints from strategic and conceptual layer 1110 and propagates refined domain-level constraints to task and operational layer 1150 through a second inter-layer communication bus 1140. Second inter-layer communication bus 1140 couples domain and functional layer 1130 and task and operational layer 1150, carrying constraint propagation signals, admissibility coordination information, and diagnostic aggregation between the two layers, without transferring raw cognitive state between them.

Task and operational layer 1150 occupies the lowest position of the hierarchy and is responsible for the active, real-time cognitive operations performed in direct response to task inputs and user interactions. An L3 executive core 1151 manages the task-level cognitive state, coordinates the components of task and operational layer 1150, and handles the moment-to-moment cognitive processing required to respond to incoming stimuli. L3 executive core 1151 operates under constraints received from domain and functional layer 1130 through inter-layer communication bus 1140 and ultimately derived from the invariants maintained in L1 invariant registry 1116. An L3 task manifold 1152 maintains the task-specific regions of the cognitive manifold that are directly engaged in active reasoning, comprising the dynamic, frequently updated representations associated with current task processing and the active reasoning state that evolves during each cognitive operation. L3 task manifold 1152 is the most frequently modified region of the hierarchical cognitive manifold and is subject to the most intensive Ricci-flow reasoning activity within hierarchical PCM system 1100.

An L3 Ricci-flow reasoning engine 1153 performs fine-grained, frequently applied geometric evolution of selected regions of L3 task manifold 1152 during active task processing. L3 Ricci-flow reasoning engine 1153 is the most frequently invoked Ricci-flow reasoning engine within hierarchical PCM system 1100, operating in direct response to task inputs and active reasoning trajectories to stabilize local curvature-derived instabilities, clarify admissibility boundaries within task-specific regions, and support rapid, reliable reasoning under the real-time demands of task processing. L3 Ricci-flow reasoning engine 1153 may be invoked in any of the operational modes described herein, with pre-traversal preconditioning, trajectory-planning coupled operation, and in-traversal stabilization modes being particularly relevant to the high-frequency task-level reasoning context. The scope of each invocation of L3 Ricci-flow reasoning engine 1153 is bounded to localized neighborhoods within L3 task manifold 1152, preventing task-level flow operations from affecting the broader geometric structure maintained at higher layers. L3 Ricci-flow reasoning engine 1153 operates within the combined constraint boundaries propagated from both strategic and conceptual layer 1110 and domain and functional layer 1130, ensuring that fine-grained task-level flow operations remain consistent with the structural commitments of all higher layers.

An L3 admission control component 1154 evaluates task-level admissibility of reasoning trajectories within task and operational layer 1150. L3 admission control component 1154 enforces the all-layer admissibility requirement of hierarchical PCM system 1100, under which outputs may be generated only when candidate reasoning trajectories satisfy admissibility conditions at task and operational layer 1150, domain and functional layer 1130, and strategic and conceptual layer 1110 simultaneously. L3 admission control component 1154 coordinates with L2 admission control component 1134 and L1 admission control component 1114 through the inter-layer communication buses to obtain cross-layer admissibility determinations for candidate trajectories that implicate multiple layers. When a trajectory satisfies all-layer admissibility requirements, L3 admission control component 1154 permits output generation; when any layer's admissibility requirement is not satisfied, output is suppressed regardless of the admissibility determination at other layers, and the system invokes appropriate fallback behaviors.

An L3 thought cache 1155 maintains task-specific memory structures and working memory representations actively engaged in current task processing, providing rapid access to the thoughts most immediately relevant to ongoing cognitive operations. An L3 language and reasoning component 1156 provides task-specific generative and analytical capabilities within task and operational layer 1150, comprising language processing and reasoning capabilities configured for the types of tasks handled at the operational level of the hierarchy. An irreversible suppression component 1157 operates within task and operational layer 1150 to prevent repeated traversal of inadmissible task-level reasoning patterns, projecting abstract representations of invalid patterns into a non-navigable reservoir within L3 task manifold 1152. In certain embodiments, suppression events recorded by irreversible suppression component 1157 are reported upward through L3 layer interface 1158 and inter-layer communication bus 1140 to domain and functional layer 1130, enabling higher-layer components to update their structural models in response to patterns of inadmissibility emerging at the task level.

An L3 layer interface 1158 provides the upward-facing boundary through which task and operational layer 1150 communicates with domain and functional layer 1130. L3 layer interface 1158 transmits diagnostic reports, admissibility summaries, and suppression event notifications upward through inter-layer communication bus 1140, providing domain and functional layer 1130 with visibility into the task-level structural conditions that may have implications for domain-level reasoning stability. L3 layer interface 1158 also implements escalation mechanisms through which instability conditions detected at the task level that exceed the remediation capacity of L3 Ricci-flow reasoning engine 1153 may be escalated to domain and functional layer 1130 for broader structural intervention. Through these upward reporting and escalation mechanisms, hierarchical PCM system 1100 ensures that structural issues arising at the task level do not propagate silently to affect higher layers, and that each layer has the information necessary to maintain its own structural health in light of the activity occurring at adjacent layers.

A shared infrastructure 1160 provides common services utilized across all three cognitive layers of hierarchical PCM system 1100. A mode selection and scheduling subsystem 1161 determines which operational mode of the Ricci-flow reasoning engine at each layer to invoke based on system state, task context, layer-specific conditions, and applicable policy, and enforces aggregate rate control across all layers to prevent excessive cumulative geometric evolution. A persistence layer 1162 provides mechanisms for serializing and restoring the cognitive state of all three layers across system shutdowns and restarts, maintaining the continuity of the conceptual manifold, domain manifold, and task manifold together with their associated accumulated structural commitments and thought representations. A sleep manager 1163 implements sleep-like states during which one or more layers temporarily reduce responsiveness to external stimuli to focus on internal cognitive maintenance, including memory consolidation, insight generation, and thought generalization within the thought caches of each layer, with background Ricci-flow maintenance operations applied at appropriate layers during such periods. An embedding system 1164 encodes newly generated thoughts from all layers into vector representations for storage in the corresponding layer thought caches, supporting semantic similarity-based retrieval during subsequent reasoning operations.

An integration and interface layer 1170 forms the connection between hierarchical PCM system 1100 and external entities. Integration and interface layer 1170 comprises an API gateway providing programmatic access to system capabilities, user interface components enabling direct interaction by human users, system connectors facilitating integration with external services and applications, and a document interface providing mechanisms for ingesting content into the thought caches of appropriate layers within the hierarchy. Human users 1180 may engage with the system through direct interaction. Applications 1181 may integrate with the system through API calls. External services 1182 may provide additional capabilities or information sources accessible through system connectors. Documents and other content 1183 may be ingested through the document interface and incorporated into the thought caches of one or more layers depending on the abstraction level and domain relevance of the content, enriching the persistent knowledge available at each layer during admissibility evaluation and reasoning.

In operation, hierarchical PCM system 1100 processes inputs received through integration and interface layer 1170 by routing them to task and operational layer 1150 for primary processing. L3 executive core 1151 coordinates the engagement of L3 Ricci-flow reasoning engine 1153 for fine-grained stabilization of relevant regions of L3 task manifold 1152, under the direction of mode selection and scheduling subsystem 1161. L3 admission control component 1154 evaluates candidate reasoning trajectories against the task-level Ricci-flow-regularized manifold geometry and coordinates cross-layer admissibility determinations with L2 admission control component 1134 and L1 admission control component 1114 through the inter-layer communication buses. Outputs are generated only when admissibility is confirmed at all three layers. Diagnostic information from task and operational layer 1150 and domain and functional layer 1130 aggregates upward to strategic and conceptual layer 1110, informing the long-horizon management of the conceptual manifold and triggering coarse-scale Ricci-flow maintenance when accumulated structural conditions warrant. Sleep manager 1163 periodically transitions appropriate layers into sleep states for memory consolidation and cognitive maintenance, with Ricci-flow background operations applied at each layer at frequencies and scales appropriate to the layer's function. Persistence layer 1162 ensures that the accumulated cognitive state of all three layers survives any system interruption, enabling hierarchical PCM system 1100 to resume operation with full hierarchical cognitive continuity and consistent enforcement of the structural constraints and invariants accumulated across its operational history.

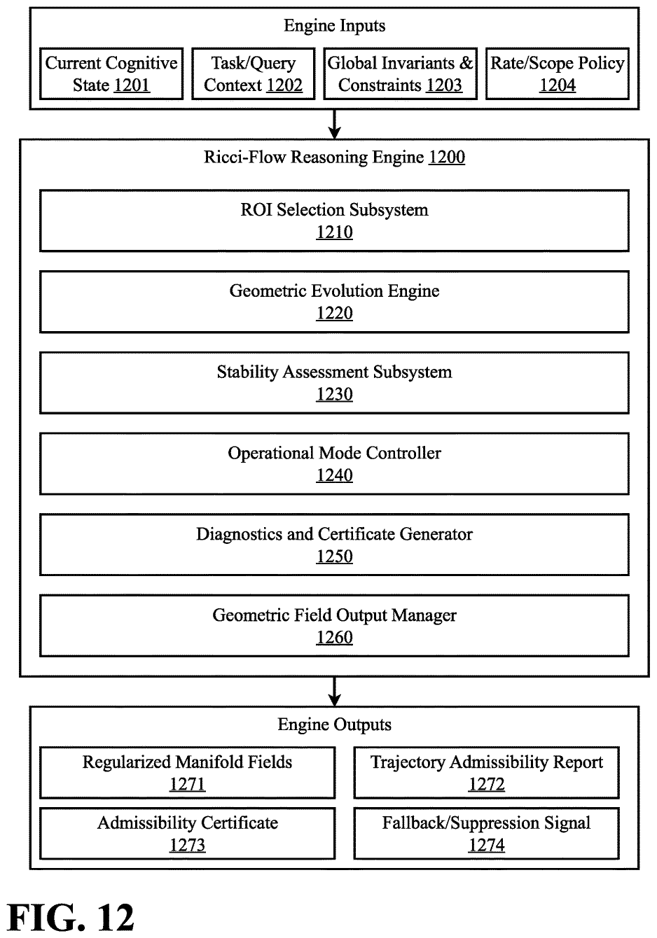

FIG. 12 is a block diagram illustrating an exemplary architecture of a Ricci-flow reasoning engine, according to an embodiment. A Ricci-flow reasoning engine 1200 is a machine-implemented subsystem configured to perform controlled, bounded-time geometric evolution of selected regions of a persistent cognitive manifold during reasoning operations within a persistent cognitive machine. Ricci-flow reasoning engine 1200 operates as a reasoning-time operator and governed control primitive rather than as an offline smoothing routine. The engine may be invoked synchronously as part of a reasoning cycle or asynchronously in response to detected instability conditions. The engine comprises various subsystems arranged in a sequential processing pipeline: a region of interest (ROI) selection subsystem 1210, a geometric evolution engine 1220, a stability assessment subsystem 1230, an operational mode controller 1240, a diagnostics and certificate generator 1250, and a geometric field output manager 1260. Ricci-flow reasoning engine 1200 receives four categories of inputs and produces four categories of outputs, with rate feedback and failure signaling paths that maintain bounded computation and hallucination-safe operation throughout the reasoning cycle.

Ricci-flow reasoning engine 1200 receives one or more categories of engine inputs. A current cognitive state input 1201 provides the engine with the present geometric configuration of the cognitive manifold, including the curvature-derived pressure values, accessibility weights, and accumulated structural commitments that define the traversal landscape within which reasoning will occur. A task and query context input 1202 conveys the nature, scope, and criticality of the current reasoning task or query. This input includes information about the goal condition, candidate regions of interest, and any competing alternative approaches that may require evaluation. A global invariants and constraints input 1203 provides the set of protected regions, epistemic horizon conditions, structural boundary conditions, and other invariants that must be preserved across all flow operations. These constraints are derived from the invariant registry of the enclosing persistent cognitive machine or, in hierarchical embodiments, from the authoritative invariant registry of the highest-level layer. A rate and scope policy input 1204 specifies the computational limits and operational parameters governing the current invocation of the engine. This input includes the maximum number of flow update steps, step size constraints, total compute budget, scope restrictions on the region of interest, and any mode-specific policy directives applicable to the current task context.

An ROI selection subsystem 1210 determines the region or regions of the cognitive manifold to which geometric evolution will be applied during the current engine invocation. ROI selection subsystem 1210 comprises several internal components that work together to identify and bound the region of interest. A manifold state analyzer samples the current curvature field of the cognitive manifold and constructs a pressure distribution map identifying regions of elevated curvature-derived pressure or structural congestion. A candidate region identifier predicts the corridor of likely traversal associated with the current task, identifies sets of competing alternative regions representing candidate solution approaches, and assembles an initial set of candidate regions of interest. A scope boundary controller defines the spatial extent of the selected region of interest in accordance with the scope constraints specified in rate and scope policy input 1204. This controller enforces the constraint boundaries derived from global invariants and constraints input 1203, ensuring that the selected region of interest does not extend into protected regions or across epistemic horizon conditions. A priority scheduler assesses the criticality of the current task and allocates the available compute budget among the components of the engine. The priority scheduler plans the sequence of flow operations to be performed, including determining whether a coarse-to-fine multi-scale sequence is warranted given the characteristics of the selected region. The outputs of ROI selection subsystem 1210 define a bounded region of interest together with an associated compute budget and operational sequence that govern the subsequent behavior of geometric evolution engine 1220.

A geometric evolution engine 1220 applies controlled, bounded-time curvature-driven geometric evolution to the region of interest selected by ROI selection subsystem 1210. Geometric evolution engine 1220 is the core computational element of Ricci-flow reasoning engine 1200 and is depicted with a reinforced boundary to indicate its central role. Geometric evolution engine 1220 comprises several internal components that implement the controlled flow process. A curvature-driven update rule implements a Ricci-flow-class transformation in which local curvature-derived pressure within the selected region is reduced or redistributed over a bounded sequence of update steps. The transformation is normalized or otherwise constrained to preserve global scale or specified invariants of the manifold. A rate controller enforces the step count limits, step size constraints, and total compute budget specified in rate and scope policy input 1204. The rate controller monitors cumulative computational expenditure against the budget allocated by the priority scheduler. The rate controller triggers early termination of the flow process if computational limits are reached or if instability conditions detected by stability assessment subsystem 1230 indicate that continued flow evolution would be counterproductive. An invariant preservation module applies the boundary conditions, penalty terms, and normalization factors derived from global invariants and constraints input 1203 as constraints on each flow update step. This module distinguishes between compressive geometric components associated with local density, capacity, and congestion that may be actively regularized by the flow process and shape-preserving components associated with relational structure, topological connectivity, and holonomy-like features that must remain invariant or evolve only within predefined limits. The invariant preservation module verifies invariant compliance following each update step. A multi-scale flow coordinator controls the execution of coarse-to-fine flow sequences when such sequences are indicated by the priority scheduler. This coordinator refines the boundaries and scope of the region of interest between scale levels based on the geometric modifications achieved at each preceding scale. The multi-scale flow coordinator verifies cross-scale consistency to ensure that flow operations at finer scales remain compatible with the structural modifications introduced at coarser scales. In hierarchical embodiments, the multi-scale flow coordinator further coordinates the application of flow operations across multiple layers of the cognitive manifold hierarchy, ensuring that flow at each layer remains within the constraint envelopes established by higher layers. The evolved geometric fields produced by geometric evolution engine 1220 are passed to stability assessment subsystem 1230 for evaluation. A rate feedback path returns computational expenditure information from geometric evolution engine 1220 to ROI selection subsystem 1210 to support dynamic adjustment of scope and budget allocation across iterative flow cycles.

A stability assessment subsystem 1230 evaluates the geometric fields produced by geometric evolution engine 1220 to determine whether the flow evolution has achieved sufficient regularization and whether conditions warrant continued flow processing, early termination, or escalation to fallback behavior. Stability assessment subsystem 1230 comprises several evaluation components. A pressure field monitor samples the post-flow curvature-derived pressure distribution within the region of interest. The pressure field monitor detects residual gradients indicative of insufficient regularization and assesses convergence of the pressure field toward a stable configuration. A trajectory stability evaluator analyzes the accessible neighborhood of candidate reasoning trajectories within the evolved manifold geometry. The trajectory stability evaluator measures admissibility margins reflecting the distance of candidate trajectories from inadmissibility boundaries and identifies trajectories that remain at risk of drifting into inadmissible regions. A convergence detector evaluates whether the evolution process has satisfied the termination conditions specified by the operational mode. The convergence detector identifies oscillatory behavior in flow outputs indicating non-convergence within the available compute budget and generates termination signals that are passed to the rate controller of geometric evolution engine 1220. A failure condition detector identifies specific failure conditions including persistence or growth of curvature-derived pressure within the region of interest beyond predefined thresholds after bounded flow evolution, collapse or fragmentation of admissible regions such that no continuous admissible trajectory exists between a start state and a goal state, violation of protected invariants or approach to prohibited boundaries during flow evolution, and incompatibility between the flow-regularized geometry and epistemic admission constraints derived from available evidence or prior irreversible commitments. Detection of a failure condition by stability assessment subsystem 1230 generates a failure signal that is transmitted to diagnostics and certificate generator 1250 through a dedicated failure signaling path to initiate fallback behavior selection.

An operational mode controller 1240 governs the invocation context and behavioral configuration of Ricci-flow reasoning engine 1200 across five distinct operational modes. In a pre-traversal preconditioning mode, the engine is invoked prior to selecting or committing to a candidate reasoning trajectory to regularize local curvature-derived structure within the region of interest and improve the stability and tractability of subsequent trajectory planning. Pre-traversal preconditioning may be applied iteratively in a coarse-to-fine sequence to address large-scale curvature concentrations before fine-grained local regularization. In a trajectory-planning coupled mode, the engine is invoked in coordination with a trajectory planner such that flow evolution and trajectory computation are interleaved or co-optimized. In this mode, the planner accounts for the fact that local traversal costs, accessibility weights, and admissibility boundaries within the region of interest may change as a result of bounded flow steps. This mode may produce trajectory-associated certificates comprising geometric and diagnostic features observed during interleaved flow evolution. In an in-traversal stabilization mode, the engine is invoked dynamically during traversal of an admitted trajectory when local instability emerges, curvature-derived pressure increases unexpectedly, or monitoring mechanisms detect approach to an admissibility boundary. This mode supports continued traversal under updated local geometry, local re-route path computation, traversal rate reduction, or traversal termination depending on the severity of the instability. In a post-traversal validation and certification mode, the engine is invoked after completion of a candidate trajectory but prior to output generation to validate that the trajectory is robustly admissible under bounded flow testing and to produce an admissibility certificate supporting output gating decisions. Failure of post-traversal validation suppresses output and may increase the probability that similar trajectory patterns will be deprioritized in the future. In a background maintenance and consolidation mode, the engine is invoked during off-task periods, low-load cycles, or scheduled maintenance windows to improve long-horizon manifold health, reduce structural congestion in regions exhibiting persistent high curvature-derived pressure, and enhance stability of frequently accessed regions without being tied to a single immediate query or task. Operational mode controller 1240 selects among these modes based on task criticality, available compute budget, current manifold health indicators, applicable deployment policy, and recent history of inadmissibility or suppression events. Operational mode controller 1240 enforces aggregate rate control over Ricci-flow reasoning across the operational session to prevent excessive cumulative geometric evolution.

A diagnostics and certificate generator 1250 produces the diagnostic artifacts, admissibility certificates, and control signals that support epistemic admission control, output gating, irreversible suppression, and fallback behavior within the enclosing persistent cognitive machine. Diagnostics and certificate generator 1250 comprises several internal components. A flow diagnostic recorder captures and stores diagnostic metadata describing the geometry and stability conditions encountered during flow evolution. This metadata includes identifiers of regions of interest in which instability was detected, measures of curvature-derived pressure or other geometric quantities that triggered termination or fallback conditions, constraint or invariant violations encountered during flow, and contextual information regarding the task or traversal state at the time of each invocation. An admissibility certificate generator encodes the stability features, admissibility margin measurements, and geometric diagnostic information observed during flow evolution into a structured certificate representation. This certificate may be stored as metadata associated with the candidate trajectory and provided to epistemic admission control for verification, thereby supporting auditability of admissibility determinations and enabling downstream components to confirm that required validation steps were completed. A suppression trigger evaluator analyzes patterns of repeated failure conditions across multiple invocations to determine whether a particular trajectory pattern or manifold region has demonstrated a persistent structural invalidity warranting irreversible suppression. When such a determination is made, the suppression trigger evaluator generates an irreversible suppression signal directed to the irreversible suppression component of the enclosing persistent cognitive machine. A fallback behavior selector determines the appropriate conservative response when flow evolution has failed to produce a stable or admissible configuration. The fallback behavior selector chooses among complete output suppression with an explicit indication that no admissible response can be generated under current constraints, a request for additional input or clarification from an external source, a switch to a lower-risk reasoning regime with a more restricted traversal policy or reduced search space, generation of a qualified or partial response that explicitly encodes uncertainty or limited confidence, and deferral of the task for later re-evaluation after background maintenance or consolidation operations. Selection among these behaviors is governed by task criticality, deployment policy, and historical system performance in similar contexts.

A geometric field output manager 1260 assembles and transmits the outputs of Ricci-flow reasoning engine 1200 to the admission control component and executive core of the enclosing persistent cognitive machine. Geometric field output manager 1260 organizes outputs into several categories. Updated pressure values reflect the modified curvature-derived pressure distribution within the evolved region of interest. Adjusted accessibility weights reflect changes in the traversability of regions and transitions within the cognitive manifold resulting from flow evolution. Modified traversal costs reflect updated local path costs that influence trajectory selection and planning. Admissibility certificates are generated by the admissibility certificate generator. Diagnostic artifacts are generated by the flow diagnostic recorder. Suppression and fallback signals are generated by the suppression trigger evaluator and fallback behavior selector respectively. These outputs are not themselves the reasoning results presented to users or downstream systems. Rather, they constitute the modified geometric fields and associated control signals that influence subsequent trajectory computation, admissibility evaluation, and output gating within the enclosing persistent cognitive machine. Geometric field output manager 1260 ensures that all outputs are properly formatted and complete before transmission. In certain embodiments, geometric field output manager 1260 may implement buffering or queuing mechanisms to manage the timing of output delivery in relation to the operational state of the receiving components.

Ricci-flow reasoning engine 1200 produces four categories of engine outputs directed to the admission control component and executive core of the enclosing persistent cognitive machine. Regularized manifold fields 1271 comprise the updated pressure values, adjusted accessibility weights, and modified traversal costs assembled by geometric field output manager 1260. These fields are applied to the relevant regions of the cognitive manifold to reflect the geometric regularization achieved during the current engine invocation. A trajectory admissibility report 1272 provides the admission control component with a structured assessment of the admissibility of candidate reasoning trajectories based on the flow-regularized manifold geometry. This report includes stability margin measurements and boundary proximity indicators that inform pre-admission evaluation and in-traversal monitoring. An admissibility certificate 1273 provides a verifiable record of the flow evolution and stability assessment performed during the current invocation. This certificate supports the output gating determination of the admission control component and provides an auditable record of the admissibility evaluation process. A fallback instruction and suppression signal 1274 conveys the fallback behavior selected by the fallback behavior selector and any irreversible suppression signal generated by the suppression trigger evaluator to the executive core and irreversible suppression component of the enclosing persistent cognitive machine. This output enables appropriate conservative responses when flow evolution has failed to identify a stable admissible trajectory.

Ricci-flow reasoning engine 1200 includes two internal feedback paths that support bounded computation and adaptive response to instability conditions. A rate feedback path couples geometric evolution engine 1220 to ROI selection subsystem 1210. This feedback path transmits computational expenditure information and residual budget availability from the rate controller back to the priority scheduler. The rate feedback path enables the priority scheduler to dynamically adjust the scope of the region of interest, the number of remaining flow steps, and the allocation of compute budget across subsequent scale levels or operational iterations in response to observed resource consumption during earlier steps of the current invocation. A failure signaling path couples stability assessment subsystem 1230 to diagnostics and certificate generator 1250. This failure signaling path transmits failure condition notifications generated by the failure condition detector to the fallback behavior selector and suppression trigger evaluator without requiring passage through the operational mode controller. This direct path ensures that failure conditions detected during flow evolution are immediately available to the fallback selection and suppression evaluation logic, enabling early and responsive initiation of conservative behaviors when instability conditions warrant. The direct failure signaling path is consistent with the hallucination-safe output policy of the enclosing persistent cognitive machine.

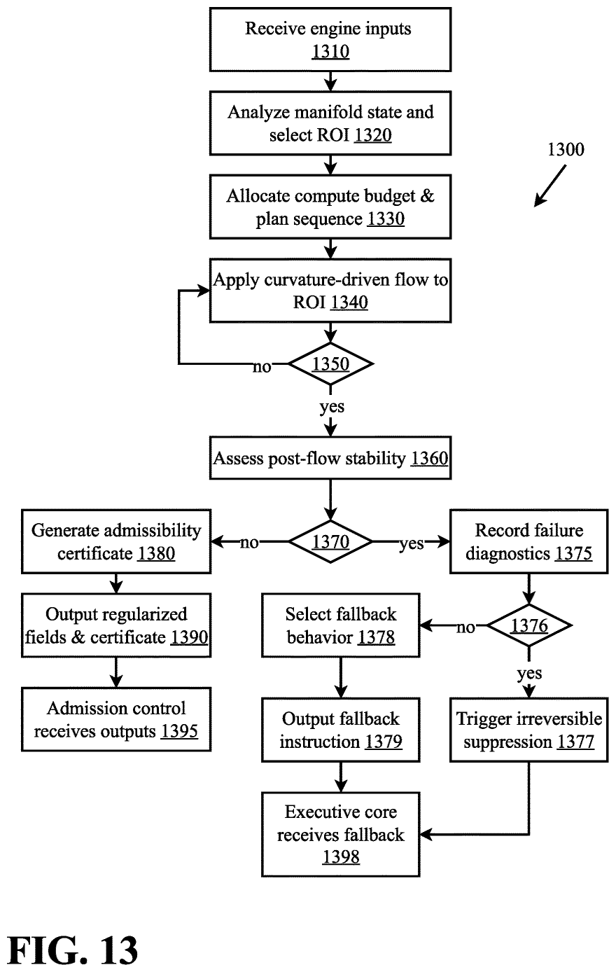

FIG. 13 is a flow diagram illustrating an exemplary method for Ricci-flow reasoning operation within a persistent cognitive machine, according to an embodiment. The method 1300 depicts the complete operational cycle of a Ricci-flow reasoning engine from initial invocation through either successful output generation or conservative fallback behavior. The method comprises two primary execution paths: a success path in which geometric evolution achieves stable regularization and produces admissibility certificates supporting output generation, and a failure path in which instability conditions or inadmissibility are detected and appropriate fallback behaviors are selected to maintain hallucination-safe operation. The method demonstrates the integration of bounded-time curvature-driven evolution, continuous stability assessment, failure detection, and epistemic discipline enforcement within a single coherent reasoning cycle.

According to the embodiment, the method process when the Ricci-flow reasoning engine is invoked in response to a reasoning task, query, or detected instability condition within the persistent cognitive machine. The invocation may occur synchronously as part of an active reasoning cycle or asynchronously during background maintenance operations. In a step 1310, the engine receives four categories of inputs necessary for bounded, constrained geometric evolution. A current cognitive state input provides the present geometric configuration of the cognitive manifold including curvature-derived pressure values, accessibility weights, and accumulated structural commitments. A task and query context input conveys the nature, scope, and criticality of the current reasoning operation including goal conditions and candidate regions of interest. A global invariants and constraints input provides the set of protected regions, epistemic horizon conditions, and structural boundary conditions that must be preserved across all flow operations. A rate and scope policy input specifies the computational limits and operational parameters governing the current invocation including maximum flow step count, step size constraints, total compute budget, and scope restrictions.

In a step 1320, the system analyzes the current manifold state and selects one or more regions of interest to which geometric evolution will be applied. The system samples the current curvature field of the cognitive manifold and constructs a pressure distribution map identifying regions of elevated curvature-derived pressure or structural congestion. The system identifies candidate regions based on predicted traversal corridors associated with the current task and assembles an initial set of regions of interest. The system defines scope boundaries for the selected regions in accordance with the scope constraints specified in the rate and scope policy input and enforces constraint boundaries derived from the global invariants and constraints input to ensure that selected regions do not extend into protected areas or across epistemic horizons. In a step 1330, the system allocates the available compute budget among the components of the reasoning engine and plans the sequence of flow operations to be performed. The system assesses the criticality of the current task to determine appropriate resource allocation priorities. The system determines whether a coarse-to-fine multi-scale flow sequence is warranted based on the characteristics of the selected region of interest and the nature of the detected curvature concentrations. The compute budget allocation and operational sequence planning performed in this step govern the subsequent behavior of the geometric evolution process.

In a step 1340, the system applies curvature-driven geometric flow to the selected region of interest. This step constitutes the core computational operation of the method and is depicted with reinforced boundaries in the flow diagram. The system executes a Ricci-flow-class transformation in which local curvature-derived pressure within the selected region is reduced or redistributed over a bounded sequence of update steps. The transformation is normalized or otherwise constrained to preserve global scale and specified invariants of the manifold. During flow evolution, the system continuously preserves the invariants specified in the global invariants and constraints input by applying boundary conditions, penalty terms, and normalization factors as constraints on each update step. The system enforces rate limits by monitoring the number of flow steps executed, the computational resources consumed, and the step size employed during evolution. At a decision point 1350, the system determines whether the flow process has converged to a stable configuration or whether the allocated compute budget has been exhausted. Convergence may be assessed based on stabilization of pressure gradients, satisfaction of termination conditions specified by the operational mode, or achievement of sufficient regularization as measured by stability indicators. If the flow has not converged and compute budget remains available, the method returns to step 1340 to continue geometric evolution. If convergence has been achieved or the budget has been exhausted, the method proceeds to stability assessment.

In a step 1360, the system assesses the stability of the evolved geometric fields produced by the flow process. The system samples the evolved pressure field within the region of interest to detect residual gradients that may indicate insufficient regularization. The system evaluates the stability of candidate reasoning trajectories within the evolved manifold geometry by analyzing accessible neighborhoods and measuring admissibility margins reflecting the distance of trajectories from inadmissibility boundaries. The system detects oscillatory behavior in flow outputs that would indicate non-convergence within the available compute budget. The system identifies specific failure conditions including persistence or growth of curvature-derived pressure beyond predefined thresholds after bounded flow evolution, collapse or fragmentation of admissible regions such that no continuous admissible trajectory exists, violation of protected invariants or approach to prohibited boundaries during flow evolution, and incompatibility between the flow-regularized geometry and epistemic admission constraints derived from available evidence or prior irreversible commitments. At a decision point 1370, the system determines whether any failure condition has been detected during stability assessment. If a failure condition is detected, the method branches to the failure path beginning at step 1375. If no failure condition is detected and stability assessment indicates that the flow-regularized geometry is suitable for supporting admissible reasoning trajectories, the method continues along the success path.

Along the success path, in a step 1380, the system generates an admissibility certificate encoding the stability features and geometric diagnostic information observed during flow evolution and stability assessment. The certificate includes stability feature encodings, admissibility margin measurements, and metadata describing the flow operations performed and the convergence conditions satisfied. The admissibility certificate provides a verifiable record of the evaluation process that may be stored as metadata associated with candidate reasoning trajectories and provided to epistemic admission control components for verification. In a step 1390, the system outputs the regularized geometric fields and the admissibility certificate to the admission control component and executive core of the enclosing persistent cognitive machine. The outputs comprise updated pressure values reflecting the modified curvature-derived pressure distribution within the evolved region of interest, adjusted accessibility weights reflecting changes in the traversability of regions and transitions within the cognitive manifold, modified traversal costs reflecting updated local path costs that influence trajectory selection and planning, the admissibility certificate generated in step 1380, and a trajectory admissibility report providing structured assessment of candidate trajectories based on the flow-regularized geometry. The method concludes at step 1395 with the admission control component receiving the outputs and using the regularized fields and admissibility certificate to inform pre-admission evaluation, in-traversal monitoring, and output gating decisions for the current reasoning operation.

Along the failure path, which is entered when decision point 1370 detects a failure condition, the system initiates conservative response procedures to maintain hallucination-safe operation. In a step 1375, the system records diagnostic metadata describing the failure condition encountered during flow evolution and stability assessment. The recorded diagnostics may include identifiers of regions of interest in which instability was detected, measures of curvature-derived pressure or other geometric quantities that triggered the failure determination, constraint or invariant violations encountered during flow, and contextual information regarding the task or traversal state at the time of failure. At a decision point 1376, the system determines whether the current failure represents a repeated failure pattern by analyzing the accumulated failure history associated with the current manifold region or trajectory pattern. If similar failures have occurred multiple times across different invocations, indicating a persistent structural invalidity within the cognitive manifold, the method proceeds to step 1377 to trigger irreversible suppression. In step 1377, the system generates an irreversible suppression signal directed to the irreversible suppression component of the enclosing persistent cognitive machine. The suppression signal causes an abstract representation of the invalid trajectory pattern or manifold region to be projected into a non-navigable reservoir, reducing future accessibility of the suppressed pattern and preventing the system from repeatedly attempting to traverse structurally invalid regions. Following irreversible suppression, the method continues to fallback behavior selection.

Whether or not irreversible suppression is triggered, the failure path proceeds through fallback behavior selection to determine the appropriate conservative response to the detected failure condition. In a step 1378, the system selects among several hallucination-safe fallback behaviors based on task criticality, deployment policy, and historical system performance in similar failure contexts. The available fallback behaviors include complete output suppression with an explicit indication to the user or downstream system that no admissible response can be generated under current constraints, a request for additional input or clarification from an external source to provide the evidence or context necessary to identify an admissible trajectory, a switch to a lower-risk reasoning regime employing a more restricted traversal policy or reduced search space, generation of a qualified or partial response that explicitly encodes uncertainty or limited confidence rather than presenting an unqualified output, and deferral of the task for later re-evaluation after background maintenance or consolidation operations have had an opportunity to improve the structural health of the relevant manifold regions. In a step 1379, the system outputs a fallback instruction reflecting the selected fallback behavior together with any suppression signal generated in step 1377 if applicable. The fallback instruction is transmitted to the executive core of the enclosing persistent cognitive machine to enable execution of the selected conservative response. The method concludes at step 1398 with the executive core receiving the fallback instruction and initiating the appropriate conservative behavior, which may include output suppression, user interaction, regime adjustment, qualification of responses, task deferral, or irreversible suppression of invalid patterns, depending on the fallback behavior selected in step 1378.

The method illustrated in FIG. 13 demonstrates several characteristics that distinguish Ricci-flow reasoning from conventional AI reasoning approaches. The method operates under explicit bounded-time constraints enforced through compute budget allocation in step 1330, rate limiting during flow evolution in step 1340, and convergence or budget exhaustion checking at decision point 1350, ensuring that geometric evolution completes within predictable computational bounds. The method continuously preserves structural invariants throughout flow evolution as specified in step 1340, preventing flow operations from violating protected regions, epistemic horizons, or other constraints that maintain the integrity of the cognitive manifold. The method implements comprehensive failure detection through stability assessment in step 1360 and decision point 1370, identifying four distinct categories of failure conditions that would render continued reasoning inadmissible. The method enforces hallucination-safe output policies through the branching structure at decision point 1370, which ensures that outputs are generated only when stability assessment confirms the absence of failure conditions, while detected failures trigger conservative fallback behaviors rather than fabricated or extrapolated outputs. The method supports irreversible suppression of persistently invalid patterns through decision point 1376 and step 1377, enabling the system to learn from repeated failures and prevent future attempts to traverse regions of the cognitive manifold that have demonstrated structural invalidity across multiple invocations.

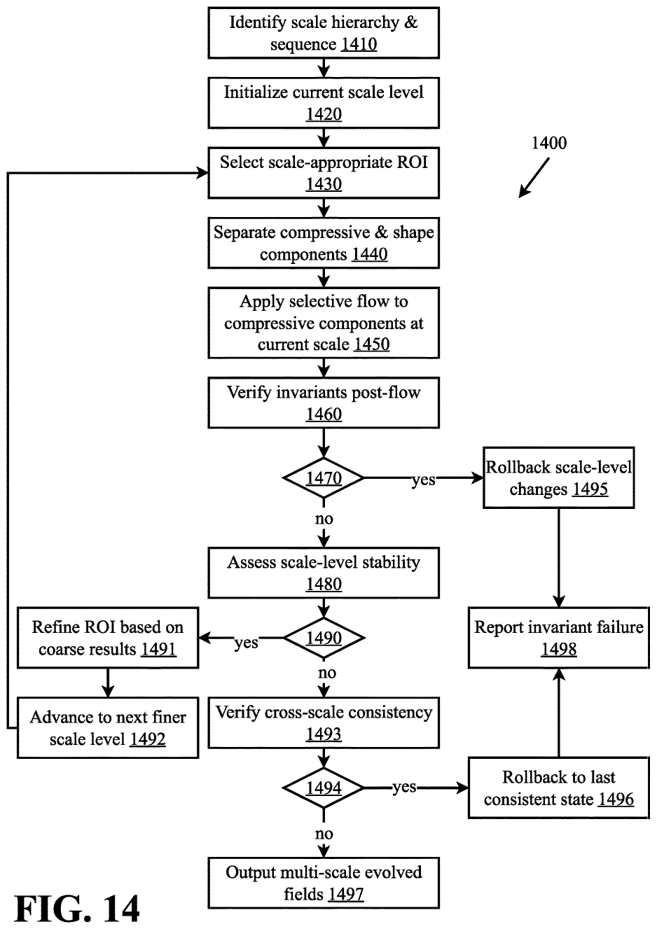

FIG. 14 is a flow diagram illustrating an exemplary method for multi-scale flow evolution with invariant preservation within a Ricci-flow reasoning engine, according to an embodiment. The method 1400 depicts the iterative application of bounded-time geometric evolution across multiple spatial or structural scales of a cognitive manifold, proceeding from coarse-scale regularization of large structural instabilities to fine-scale refinement of local geometry. The method demonstrates the critical distinction between compressive geometric components that may be actively regularized by flow operations and shape-preserving components that must remain invariant to prevent loss of meaningful relational structure. The method further illustrates comprehensive invariant verification performed after each scale-level flow operation and cross-scale consistency verification performed after completion of the multi-scale sequence to ensure that geometric modifications at different scales remain compatible with one another and with the structural commitments of the cognitive manifold.

According to the embodiment, the process begins when multi-scale flow evolution is initiated based on a determination by the priority scheduler of the Ricci-flow reasoning engine that the characteristics of the selected region of interest warrant a coarse-to-fine sequence rather than single-scale flow. In a step 1410, the system identifies the scale hierarchy and sequence for the multi-scale flow operation. The system analyzes the curvature distribution within the region of interest to detect distinct scale levels at which structural instabilities are concentrated. Large-scale curvature concentrations that span broad regions of the manifold are distinguished from fine-scale instabilities localized to small neighborhoods. The system plans a coarse-to-fine processing sequence that will address large-scale structural issues before applying fine-grained regularization. The system sets scale thresholds that define the boundaries between different scale levels and determine the spatial extent of regions of interest appropriate to each scale. In a step 1420, the system initializes the current scale level to the coarsest scale in the identified hierarchy. The system defines the initial region of interest extent appropriate to the coarse scale, which typically encompasses a broader area of the cognitive manifold than would be selected for fine-scale operations. This initialization establishes the starting point for the iterative multi-scale process.

In a step 1430, the system selects a scale-appropriate region of interest for the current scale level. The region of interest extent is defined based on the spatial characteristics appropriate to the current scale, with coarser scales employing broader regions and finer scales focusing on more localized neighborhoods. The system applies scale-level constraint boundaries derived from the global invariants and constraints, ensuring that the region of interest at the current scale does not extend into protected regions or across epistemic horizon conditions. The scale-appropriate region selection ensures that flow operations at each scale address instabilities at the appropriate level of granularity without introducing inappropriate modifications at other scales. In a step 1440, the system performs a critical separation of the geometric structure within the selected region into compressive components and shape-preserving components. Compressive components are identified as those geometric features associated with local density, curvature-derived pressure, and structural congestion that reflect capacity constraints or accumulated load within the cognitive manifold. These compressive components may be actively regularized by flow operations to reduce instability without loss of meaningful information. Shape-preserving components are identified as those geometric features associated with relational structure, topological connectivity, and holonomy-like features that encode the meaningful semantic relationships among representations within the cognitive manifold. These shape-preserving components must remain invariant during flow evolution to prevent semantic drift or loss of accumulated knowledge. The separation performed in this step enables selective application of geometric evolution in the subsequent step.

In a step 1450, the system applies selective geometric flow to the compressive components at the current scale while preserving the shape-preserving components identified in step 1440. This step constitutes the core computational operation of each scale-level iteration and is depicted with reinforced boundaries in the flow diagram. The system regularizes the compressive components through curvature-driven pressure reduction or redistribution appropriate to the current scale level. The regularization acts to reduce structural congestion and alleviate capacity constraints without modifying the relational or topological structure that encodes semantic information. The system actively preserves the shape-preserving components by constraining flow evolution such that these components remain unchanged throughout the flow process. The system enforces invariant constraints derived from the global invariants and constraints input throughout flow evolution at the current scale. The system applies scale-level rate limits that bound the computational expenditure and the number of flow update steps permitted at the current scale, ensuring that each scale-level operation completes within predictable computational bounds. In a step 1460, the system verifies that all invariants have been preserved following the scale-level flow operation. The system checks that protected regions remain intact and have not been modified by the flow evolution. The system verifies that boundary conditions derived from global constraints have not been violated. The system confirms that shape-preserving components have remained unchanged throughout the flow process, ensuring that no semantic drift or loss of relational structure has occurred. At a decision point 1470, the system determines whether any invariant violation has been detected during the post-flow verification. If an invariant violation is detected, the method branches to the failure path beginning at step 1495. If all invariants are confirmed to be preserved, the method continues along the success path.

In a step 1480, the system assesses the stability and effectiveness of the regularization achieved at the current scale level. The system measures the curvature reduction achieved by the scale-level flow operation by comparing post-flow curvature-derived pressure values to the pre-flow baseline. The system evaluates whether the regularization has been effective in addressing the structural instabilities appropriate to the current scale without introducing new instabilities or transferring instability to other regions. The scale-level stability assessment informs the decision about whether to proceed to finer scales or whether additional iterations at the current scale may be warranted. At a decision point 1490, the system determines whether finer scales remain to be processed in the multi-scale sequence. If the current scale is not yet the finest scale in the planned hierarchy and additional fine-grained regularization is warranted based on the stability assessment, the method proceeds to the refinement loop. If all planned scale levels have been processed and no finer scales remain, the method proceeds to cross-scale consistency verification. In a step 1491 within the refinement loop, the system refines the region of interest based on the results of the coarse-scale flow operation. The system narrows the scope of the region of interest to focus on the specific neighborhoods within the broader coarse-scale region that require fine-grained regularization. The system identifies regions where residual instabilities persist after coarse-scale flow or where fine-scale structure requires attention. This refinement process ensures that fine-scale flow operations are applied efficiently to the regions where they are most needed rather than being applied uniformly across the entire coarse-scale region. In a step 1492, the system advances to the next finer scale level in the hierarchy. The system updates the current scale parameter and adjusts the spatial extent and granularity of subsequent operations to match the characteristics of the finer scale. Following advancement to the finer scale, the method returns to step 1430 to repeat the scale-appropriate region selection, component separation, selective flow, and invariant verification processes at the new finer scale level. This iterative loop continues until all planned scale levels have been processed.

Following completion of all scale-level iterations, the method proceeds to cross-scale consistency verification. In a step 1493, the system verifies that the geometric modifications introduced at different scale levels are compatible with one another and have not produced conflicting structural changes. The system ensures that fine-scale changes remain compatible with the coarse-scale modifications that preceded them, confirming that fine-grained regularization has not introduced instabilities or contradictions relative to the broader structural adjustments made at coarser scales. The system checks global manifold coherence by evaluating whether the cumulative effect of all scale-level flow operations has maintained the overall structural integrity of the cognitive manifold. The system verifies that no conflicting structural changes have been introduced across different scales that would result in inconsistent or unstable geometry. At a decision point 1494, the system determines whether any cross-scale consistency violation has been detected. If a consistency violation is identified, indicating that modifications at different scales have produced incompatible or conflicting structural changes, the method branches to the failure path beginning at step 1496. If cross-scale consistency is confirmed and no violations are detected, the method continues along the success path. In a step 1497, the system outputs the multi-scale evolved geometric fields produced by the complete sequence of scale-level flow operations. The system transmits the regularized geometry reflecting the cumulative effect of flow evolution across all processed scales. The system provides scale-level diagnostic reports documenting the curvature reduction achieved at each scale, the invariant verifications performed, and the cross-scale consistency checks completed. These outputs enable the enclosing Ricci-flow reasoning engine to utilize the multi-scale regularized geometry for subsequent stability assessment and admissibility evaluation. The method concludes with the multi-scale flow evolution complete and the evolved fields available for use in the broader reasoning cycle.

The method includes two failure paths that handle violations detected during multi-scale flow evolution. The first failure path is entered when decision point 1470 detects an invariant violation following a scale-level flow operation. In a step 1495, the system rolls back the scale-level changes that produced the invariant violation. The system restores the cognitive manifold to the pre-flow state that existed before the violating flow operation was applied at the current scale level. This rollback ensures that invariant-violating modifications are not allowed to persist in the cognitive manifold. Following rollback, the method proceeds to failure reporting. The second failure path is entered when decision point 1494 detects a cross-scale consistency violation after completion of the multi-scale sequence. In a step 1496, the system rolls back to the last consistent state that existed before the cross-scale consistency violation was introduced. This may require undoing modifications from one or more scale levels to restore cross-scale coherence. The system restores the cognitive manifold to a state in which all scale-level modifications are mutually compatible and structurally coherent. Both failure paths converge at step 1498 where the system reports the invariant or consistency failure to the diagnostics and certificate generator of the Ricci-flow reasoning engine. The failure report includes diagnostic information identifying the nature of the violation, the scale level at which the violation was detected, the state to which the manifold was rolled back, and any other contextual information relevant to understanding and addressing the failure. The failure report enables the broader reasoning cycle to invoke appropriate fallback behaviors as described in the method of FIG. 13.

The method illustrated in FIG. 14 demonstrates several characteristics that enable effective and safe multi-scale geometric evolution. The method implements a coarse-to-fine processing sequence as established in step 1410 and enforced through the iterative loop spanning steps 1430 through 1492, ensuring that large-scale structural instabilities are addressed before fine-grained regularization is applied. This sequencing prevents the introduction of fine-scale modifications that could be undermined or rendered incompatible by subsequent coarse-scale adjustments. The method implements selective evolution through the separation of compressive and shape-preserving components in step 1440 and the application of flow exclusively to compressive components in step 1450. This selectivity ensures that geometric regularization addresses capacity constraints and structural congestion without modifying the relational or topological structure that encodes semantic information, thereby preventing semantic drift during multi-scale evolution. The method enforces comprehensive invariant preservation through post-flow verification at each scale level in steps 1460 and 1470, preventing the accumulation of small invariant violations across multiple scale levels that could result in significant structural damage. The method verifies cross-scale consistency in steps 1493 and 1494 following completion of the multi-scale sequence, ensuring that modifications introduced at different scales are mutually compatible and that the cumulative effect of multi-scale evolution maintains global manifold coherence. The method implements safe rollback mechanisms in steps 1495 and 1496 that restore the cognitive manifold to valid states when violations are detected, preventing the persistence of structural damage and enabling the system to report failures without leaving the manifold in an inconsistent or invalid configuration. These characteristics collectively enable multi-scale flow evolution that achieves more effective regularization than single-scale approaches while maintaining the structural integrity and semantic coherence of the cognitive manifold.

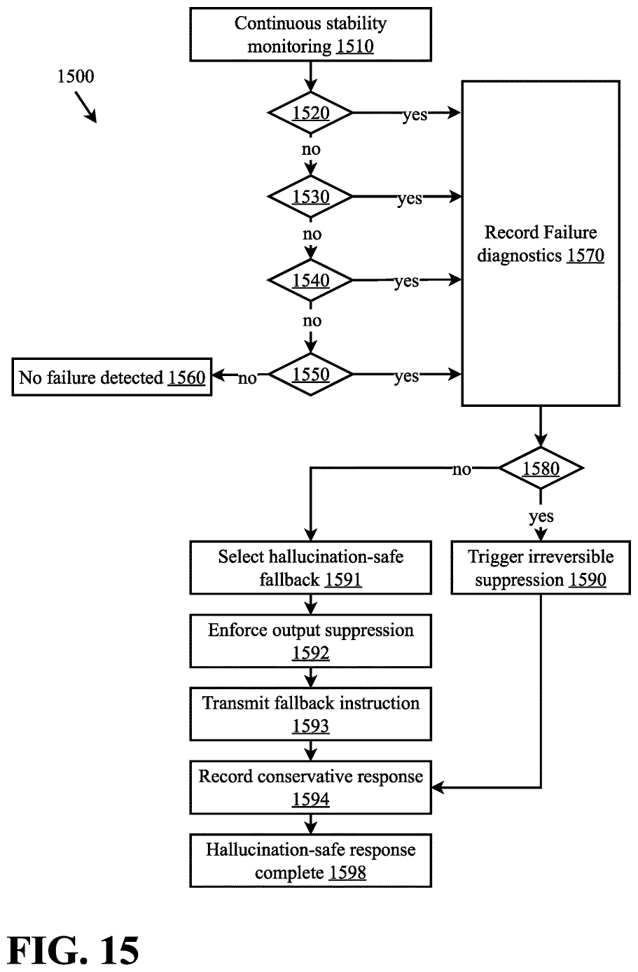

FIG. 15 is a flow diagram illustrating an exemplary method for failure detection and hallucination-safe fallback within a Ricci-flow reasoning engine and the broader persistent cognitive machine, according to an embodiment. The method 1500 depicts continuous monitoring for four distinct categories of failure conditions, diagnostic recording of detected failures, analysis of failure patterns to trigger irreversible suppression when appropriate, selection of conservative fallback behaviors based on task criticality and deployment policy, and enforcement of output suppression to prevent fabrication or extrapolation when no admissible reasoning trajectory exists. The method demonstrates the integration of proactive failure detection, bounded failure handling, irreversible suppression of persistently invalid patterns, and hallucination-safe output policies within a coherent conservative response framework that prioritizes epistemic discipline over superficial helpfulness.

According to an embodiment, the process begins when stability monitoring is initiated within the Ricci-flow reasoning engine. Stability monitoring may begin at the start of a reasoning cycle, following application of geometric flow evolution, or as part of ongoing in-traversal monitoring during active reasoning operations. In a step 1510, the system performs continuous stability monitoring throughout the reasoning process. This step constitutes the core observational operation of the method and is depicted with reinforced boundaries in the flow diagram. The system monitors the evolution of the pressure field within the cognitive manifold, tracking changes in curvature-derived pressure values and detecting growth or persistence of pressure beyond expected regularization effects. The system tracks accessibility margins by measuring the distance of candidate reasoning trajectories from admissibility boundaries within the flow-regularized manifold geometry. The system observes trajectory stability by evaluating whether candidate paths remain within accessible neighborhoods and whether local perturbations would cause trajectories to drift into inadmissible regions. The system detects gradient changes in the pressure field that may indicate insufficient regularization or the emergence of new instabilities during reasoning. The system measures the distance to admissibility boundaries to determine how close the current reasoning state is to violating structural constraints or epistemic limits. This comprehensive monitoring provides the observational foundation for the four failure detection decisions that follow.

The method evaluates four distinct categories of failure conditions through a sequence of decision points. At a decision point 1520, the system determines whether curvature-derived pressure within the region of interest has persisted or grown beyond predefined thresholds after bounded flow evolution. Pressure persistence indicates that flow regularization has not achieved sufficient reduction of structural instability. Pressure growth indicates that flow operations have exacerbated rather than alleviated curvature concentrations. If pressure persistence or growth is detected, the method branches to the failure path beginning at step 1570. If pressure has been adequately reduced, the method continues to the next failure check. At a decision point 1530, the system determines whether admissible regions within the cognitive manifold have collapsed or fragmented such that no continuous admissible trajectory exists between the start state and the goal state. Admissibility collapse indicates that flow evolution or structural changes have eliminated viable reasoning paths. Region fragmentation indicates that admissible regions have become disconnected, preventing traversal from one to another. If admissibility collapse or fragmentation is detected, the method branches to the failure path. If admissible regions remain intact and connected, the method continues. At a decision point 1540, the system determines whether any protected invariant has been violated or whether the reasoning process has approached prohibited boundaries during flow evolution or trajectory traversal. Invariant violations indicate that flow operations or reasoning steps have breached structural constraints that must be preserved to maintain manifold integrity. Boundary approach indicates proximity to epistemic horizons or protected regions that would render further reasoning inadmissible. If invariant violation is detected, the method branches to the failure path. If all invariants remain satisfied, the method continues. At a decision point 1550, the system determines whether the flow-regularized geometry is incompatible with epistemic admission constraints derived from available evidence or prior irreversible commitments. Epistemic incompatibility indicates that the manifold geometry, though structurally sound, does not support reasoning conclusions that are consistent with the evidence base or structural commitments of the system. If epistemic incompatibility is detected, the method branches to the failure path. If no failure condition is detected across all four categories, the method proceeds to step 1560 where the system confirms that no failure has been detected and permits the reasoning cycle to continue toward output generation with appropriate admissibility certificates.

When any of the four failure detection decisions identifies a failure condition, the method enters the failure processing path. In a step 1570, the system records comprehensive failure diagnostics documenting the nature, context, and characteristics of the detected failure. The system captures the specific failure type among the four categories: pressure persistence beyond thresholds indicating insufficient regularization, admissibility collapse indicating elimination of continuous viable paths, invariant violation indicating breach of protected structural constraints, or epistemic incompatibility indicating contradiction with available evidence. The system records the context in which the failure occurred, including identifiers of the region of interest where the failure was detected, the curvature-derived pressure values and gradients that characterized the failure state, the task context describing the reasoning operation that was being performed when failure occurred, and a timestamp enabling temporal analysis of failure patterns. The system updates the failure history associated with the relevant manifold regions, trajectory patterns, or task types to support subsequent pattern detection and irreversible suppression decisions. The failure diagnostics recorded in this step provide the evidentiary foundation for both immediate fallback behavior selection and longer-term learning about structural invalidity within the cognitive manifold.

Following failure diagnostics recording, the system analyzes the accumulated failure history to determine whether irreversible suppression is warranted. At a decision point 1580, the system determines whether the current failure represents a repeated failure pattern by examining the failure history associated with similar manifold regions, trajectory patterns, or task configurations. The system identifies repeated patterns based on multiple failures occurring in similar contexts, similar failure types occurring repeatedly for the same reasoning goals, or persistent structural invalidity that survives across multiple flow evolution attempts. If a repeated failure pattern is detected, indicating that the underlying structural issue is persistent rather than transient and that continued attempts to traverse the affected region are unlikely to succeed, the method proceeds to trigger irreversible suppression. If the current failure appears to be isolated rather than part of a repeated pattern, the method proceeds directly to fallback behavior selection without suppression. In a step 1590, when repeated failure patterns warrant irreversible suppression, the system triggers the irreversible suppression mechanism of the enclosing persistent cognitive machine. The system projects an abstract representation of the invalid trajectory pattern or structurally problematic manifold region into a non-navigable reservoir within the cognitive manifold. This projection reduces future accessibility of the suppressed pattern by modifying the accessibility weights and admissibility boundaries within the manifold such that the pattern becomes structurally unavailable for traversal in future reasoning cycles. The irreversible nature of the suppression ensures that the system does not waste computational resources repeatedly attempting to traverse regions that have demonstrated persistent structural invalidity. Following suppression, the method proceeds to fallback behavior selection to determine the appropriate response for the current reasoning cycle.

Whether or not irreversible suppression is triggered, the failure processing path proceeds through fallback behavior selection to determine the appropriate conservative response to the detected failure condition. In a step 1591, the system selects among five hallucination-safe fallback behaviors based on task criticality, deployment policy, historical system performance, and the specific characteristics of the detected failure. The available fallback behaviors are complete output suppression with explicit notice, in which the system provides no generated output and instead explicitly indicates to the user or downstream system that no admissible response can be generated under current constraints, thereby prioritizing transparency over superficial helpfulness. Request for additional input or clarification, in which the system solicits additional information from an external source that might provide the evidence or context necessary to identify an admissible reasoning trajectory. Switch to a lower-risk reasoning regime, in which the system adopts a more restricted traversal policy, reduces the search space, or applies more conservative admissibility criteria to increase the probability of finding a safe reasoning path. Generation of a qualified or partial response, in which the system provides output but explicitly encodes uncertainty, limited confidence, or partial coverage rather than presenting an unqualified conclusion that might be interpreted as having stronger epistemic support than is warranted. Deferral of the task for background maintenance, in which the system postpones the reasoning operation until scheduled maintenance windows or consolidation operations have had an opportunity to improve the structural health of the relevant manifold regions. The selection among these behaviors is governed by deployment policies that may prioritize different behaviors for different task criticalities, user preferences that may indicate tolerance for uncertainty or preference for explicit non-response, and historical performance data indicating which fallback behaviors have been most effective in similar failure contexts.

Following fallback behavior selection, the method enforces the conservative response and ensures that hallucination-safe policies are maintained. In a step 1592, the system enforces output suppression to prevent fabrication or extrapolation when no admissible reasoning trajectory exists. This step is depicted with reinforced boundaries to emphasize its critical role in hallucination prevention. The system blocks any unqualified output generation that would present fabricated or extrapolated conclusions as if they had epistemic support from the evidence base or structural commitments of the cognitive manifold. The enforcement of output suppression occurs before any generation process is initiated, ensuring that inadmissible reasoning paths never produce outputs that could mislead users or downstream systems. The output suppression enforcement is unconditional when failure conditions are detected, overriding any preferences for helpfulness or completion that might otherwise bias the system toward generating responses despite insufficient epistemic support. In a step 1593, the system transmits the fallback instruction to the executive core and admission control components of the enclosing persistent cognitive machine. The transmitted instruction specifies the selected fallback behavior, conveys diagnostic metadata describing the failure condition that triggered the fallback, and includes any irreversible suppression signal generated in step 1590 if applicable. The fallback instruction enables the executive core to execute the appropriate conservative response, whether that involves presenting an explicit non-response to the user, requesting additional input, adjusting reasoning parameters, generating a qualified output, or deferring the task. In a step 1594, the system records the conservative response for auditability and performance analysis. The system logs the fallback decision including the failure type that triggered it, the fallback behavior that was selected, the context in which the decision was made, and the ultimate outcome of the conservative response. The system updates performance metrics tracking the frequency of different failure types, the effectiveness of different fallback behaviors in different contexts, and the overall rate of hallucination prevention versus task completion across the operational history of the system. The method concludes at step 1598 with the hallucination-safe response complete and the conservative fallback successfully implemented, ensuring that the system has maintained epistemic discipline rather than fabricating outputs to superficially satisfy completion preferences.

The method illustrated in FIG. 15 demonstrates several characteristics that enable robust failure detection and hallucination-safe operation. The method implements comprehensive failure detection through four distinct failure condition checks in decision points 1520, 1530, 1540, and 1550, ensuring that multiple categories of structural and epistemic failure are detected rather than relying on a single failure criterion. The method enforces proactive output suppression in step 1592 before any generation occurs when failure is detected, preventing the system from fabricating or extrapolating outputs and then attempting to filter them after the fact. The method implements pattern-based irreversible suppression through decision point 1580 and step 1590, enabling the system to learn from repeated failures and prevent future wasteful attempts to traverse structurally invalid regions of the cognitive manifold. The method provides multiple conservative fallback behaviors in step 1591 rather than a single failure mode, allowing the system to select context-appropriate responses that balance epistemic discipline with operational effectiveness. The method maintains comprehensive diagnostic records through steps 1570 and 1594, supporting auditability of failure detection decisions, analysis of failure patterns over time, and continuous improvement of failure handling policies based on observed performance. The method prioritizes transparency in step 1591 by including explicit non-response with notice as a primary fallback option, ensuring that users and downstream systems understand when the system cannot generate admissible outputs rather than receiving fabricated responses that superficially appear legitimate. These characteristics collectively implement a hallucination-safe operational paradigm in which the system consistently refuses to generate outputs when epistemic support is insufficient, thereby maintaining the integrity and trustworthiness of the persistent cognitive machine across extended operational deployments.

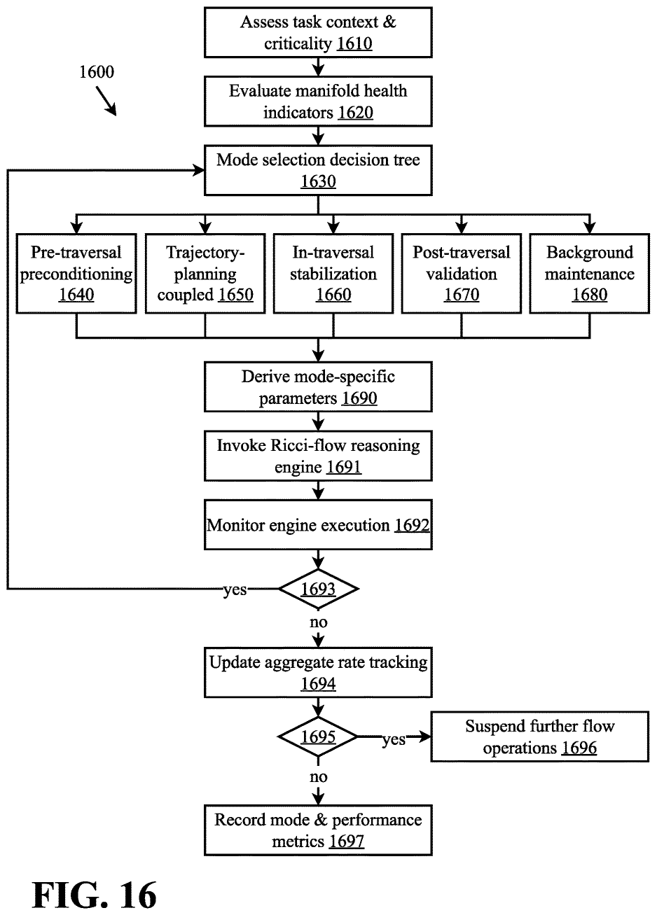

FIG. 16 is a flow diagram illustrating an exemplary method for operational mode selection and adaptive invocation within a Ricci-flow reasoning engine, according to an embodiment. The method 1600 depicts the selection among five distinct operational modes based on task context, manifold health indicators, and deployment policy, the derivation of mode-specific parameters governing rate limits and scope constraints, the invocation and monitoring of the reasoning engine under bounded control, dynamic mode switching when execution conditions warrant re-selection, aggregate rate control enforcement across multiple invocations within a session, and performance recording to enable continuous improvement of mode selection heuristics. The method demonstrates how the Ricci-flow reasoning engine adapts its operational behavior to different reasoning contexts while maintaining bounded computation and preventing excessive cumulative geometric evolution through session-level rate enforcement.

According to the embodiment, the process begins when a reasoning task is initiated within the persistent cognitive machine. The task initiation may occur in response to an external query, an internally generated goal, a scheduled maintenance operation, or detection of instability during ongoing reasoning processes. In a step 1610, the system assesses the context and criticality of the reasoning task. The system evaluates task criticality by classifying the task as safety-critical, high-value, or routine based on deployment policy, user specifications, or the nature of the reasoning domain. Safety-critical tasks may include reasoning operations that inform decisions affecting human safety, financial security, or other high-stakes outcomes. High-value tasks may include complex analytical operations, strategic planning, or other reasoning processes where accuracy and thoroughness are prioritized over rapid completion. Routine tasks may include standard queries, maintenance operations, or other reasoning processes where computational efficiency is prioritized. The system determines the time and compute budget available for the current reasoning cycle based on system resource availability, user-specified time constraints, and competing task priorities. The system identifies user-specific or deployment policy requirements that may constrain or guide mode selection, such as mandatory post-traversal validation for certain task types or preferences for particular fallback behaviors. In a step 1620, the system evaluates manifold health indicators to assess the structural condition of the cognitive manifold regions relevant to the current task. The system samples the current curvature distribution and pressure levels within regions likely to be traversed during reasoning. The system assesses structural congestion in relevant regions by identifying areas of high curvature concentration, capacity constraints, or accumulated load. The system reviews recent inadmissibility or suppression event history associated with the relevant regions to identify areas that have demonstrated persistent structural problems. The manifold health assessment provides critical input to mode selection by identifying whether preconditioning, stabilization, or other specialized modes are warranted.

In a step 1630, the system executes a mode selection decision tree that applies policy rules and context evaluation to select the most appropriate operational mode for the current reasoning task. This step is depicted with reinforced boundaries to emphasize its central role in adaptive invocation. The mode selection decision tree evaluates the task criticality assessment from step 1610, the manifold health indicators from step 1620, and applicable deployment policies to determine which of five operational modes best matches the current context. The decision tree may implement hard rules that mandate specific modes for certain task types, such as requiring post-traversal validation for all safety-critical tasks, and learned heuristics that recommend modes based on historical performance in similar contexts. The method branches into five distinct operational mode paths. In a pre-traversal preconditioning mode 1640, the Ricci-flow reasoning engine is invoked before trajectory selection to regularize the region of interest and improve the stability and tractability of subsequent trajectory planning. This mode is selected when manifold health indicators reveal elevated curvature or structural congestion that would impede effective trajectory planning, when the task is complex enough to warrant investment in preparation, or when policy requires proactive regularization. In a trajectory-planning coupled mode 1650, the reasoning engine is invoked in coordination with trajectory planning such that flow evolution and trajectory computation are interleaved or co-optimized. This mode is selected when the relationship between geometry and trajectory selection is sufficiently dynamic that joint optimization provides significant benefits, when moderate manifold instability requires ongoing adjustment during planning, or when the task involves exploration of multiple competing alternatives. In an in-traversal stabilization mode 1660, the reasoning engine is invoked dynamically during traversal of an admitted trajectory to respond to detected instability in real time. This mode is selected when monitoring indicates emergent instability during active reasoning, when traversal approaches admissibility boundaries requiring corrective action, or when the manifold is generally healthy but localized instabilities may arise unpredictably during traversal. In a post-traversal validation mode 1670, the reasoning engine is invoked after trajectory completion but prior to output generation to verify robust admissibility and generate an admissibility certificate. This mode is selected when task criticality requires high-confidence validation before output, when deployment policy mandates certification for certain task types, or when the trajectory traversed regions with marginal stability that warrant verification. In a background maintenance mode 1680, the reasoning engine is invoked during off-task periods or low-load cycles to improve long-horizon manifold health without being tied to a specific immediate query. This mode is selected when system resources are available but no active tasks are pending, when manifold health metrics indicate degradation requiring attention, or when scheduled maintenance windows have arrived.

Following mode selection, all five mode paths converge to parameter derivation and engine invocation. In a step 1690, the system derives mode-specific parameters that govern the operation of the Ricci-flow reasoning engine for the selected mode. The system sets rate limits including maximum flow step count, step size constraints, and total compute budget appropriate to the selected mode and task criticality. Pre-traversal preconditioning and background maintenance modes may be allocated larger compute budgets to support thorough regularization, while in-traversal stabilization modes may be allocated smaller budgets to ensure rapid response. The system defines scope constraints including region of interest extent and boundary conditions appropriate to the selected mode. Pre-traversal modes may employ broader ROI extents to address large-scale instabilities, while in-traversal modes may employ narrower ROI extents focused on local neighborhoods requiring stabilization. The system configures convergence criteria and termination conditions specific to the selected mode. Post-traversal validation modes may employ strict convergence criteria to ensure robust admissibility, while background maintenance modes may employ relaxed criteria allowing incremental improvement over multiple cycles. In a step 1691, the system invokes the Ricci-flow reasoning engine with the selected mode and derived parameters. This step constitutes the core invocation operation and is depicted with reinforced boundaries. The engine executes geometric evolution under bounded control according to the mode-specific parameters, applying curvature-driven flow to the selected region of interest while enforcing rate limits, scope constraints, and invariant preservation requirements. In a step 1692, the system monitors the execution of the reasoning engine throughout its operation. The system tracks computational expenditure against the allocated budget, enabling early termination if limits are approached. The system observes stability indicators and convergence progress to assess whether the flow evolution is proceeding effectively or whether adjustment may be warranted.

At a decision point 1693, the system determines whether dynamic mode switching or re-invocation is needed based on observations from the monitoring step. Dynamic mode switching may be warranted when execution reveals that the initially selected mode is not well-suited to the actual conditions encountered, when stability indicators suggest that a different mode would be more effective, when computational expenditure is trending toward budget exhaustion without achieving the intended regularization, or when convergence is not occurring within expected parameters. If dynamic mode switching is needed, the method returns to the mode selection decision tree at step 1630 to re-evaluate the appropriate mode given updated information about manifold conditions and execution progress. The mode selection may be adjusted to a different mode, or the same mode may be re-selected with adjusted parameters. This adaptive loop enables the system to respond to execution conditions rather than being rigidly committed to initial mode selection decisions. If no mode switching is needed and engine execution has completed successfully, the method proceeds to aggregate rate tracking.

In a step 1694, the system updates aggregate rate tracking to monitor cumulative geometric evolution across all Ricci-flow reasoning engine invocations within the current session. The system accumulates the total flow evolution performed across the current invocation and all previous invocations in the session, maintaining a running total of flow steps executed, computational resources consumed, and cumulative geometric modifications applied. The system enforces session-level rate limits that bound the total amount of geometric evolution permitted within a single reasoning session to prevent excessive cumulative evolution that could destabilize the cognitive manifold or compromise long-horizon coherence. At a decision point 1695, the system determines whether the aggregate rate limit has been exceeded. If the cumulative geometric evolution across the session has reached or exceeded the session-level limit, indicating that further flow operations would risk excessive modification of the manifold, the method proceeds to suspend further flow operations. If aggregate limits remain within acceptable bounds, the method proceeds to performance recording. In a step 1696, when aggregate rate limits are exceeded, the system suspends further flow operations for the remainder of the current session. The suspension prevents additional geometric evolution that could compromise manifold stability or structural integrity through excessive cumulative modification. The system may still permit reasoning operations that do not involve flow evolution, or may defer tasks requiring additional flow until a new session begins with reset aggregate counters. Following suspension, the method proceeds to performance recording to document the circumstances that led to aggregate limit enforcement.

In a step 1697, the system records mode selection decisions and performance metrics to support continuous improvement of the mode selection process. The system logs the mode selection decision documenting which mode was selected, the rationale for the selection based on task context and manifold health, and any dynamic mode switches that occurred during execution. The system records computational cost including the actual flow steps executed, compute budget consumed, and wall-clock time required for the reasoning cycle. The system records effectiveness metrics including whether the selected mode achieved the intended regularization, whether admissibility was successfully established or validated, and whether the reasoning cycle resulted in successful output generation or required fallback. The system updates mode selection heuristics based on the observed outcomes, adjusting learned recommendations to favor modes that have proven effective in similar contexts and to avoid modes that have underperformed. The performance recording enables the mode selection process to improve over time through accumulation of operational experience. The method concludes at step 1698 with the mode-adaptive invocation complete and the Ricci-flow reasoning engine having executed under bounded control with parameters tailored to the specific reasoning context.

The method illustrated in FIG. 16 demonstrates several characteristics that enable effective adaptive invocation of Ricci-flow reasoning. The method implements context-sensitive mode selection through the decision tree in step 1630 that evaluates task criticality, manifold health, and deployment policy to select among five distinct operational modes rather than applying a single fixed invocation pattern to all reasoning tasks. The method provides five specialized operational modes in steps 1640 through 1680, each optimized for specific invocation contexts including pre-traversal preparation, coupled planning and evolution, in-traversal stabilization, post-traversal validation, and background maintenance. The method derives mode-specific parameters in step 1690 rather than using fixed parameters across all modes, allowing rate limits, scope constraints, and convergence criteria to be tailored to the characteristics and requirements of each operational mode. The method supports dynamic mode switching through decision point 1693 and the adaptive loop back to mode selection, enabling the system to adjust its approach when execution conditions differ from initial expectations rather than being rigidly committed to initial decisions. The method enforces aggregate rate control through steps 1694 through 1696, preventing excessive cumulative geometric evolution across multiple invocations within a session that could compromise manifold stability despite each individual invocation remaining within its allocated budget. The method implements continuous learning through step 1697 by recording mode selection decisions, computational costs, effectiveness metrics, and updating selection heuristics based on observed outcomes, enabling the mode selection process to improve over time. These characteristics collectively enable the Ricci-flow reasoning engine to adapt its operational behavior to diverse reasoning contexts while maintaining bounded computation, preventing excessive evolution, and continuously improving its mode selection effectiveness through operational experience.

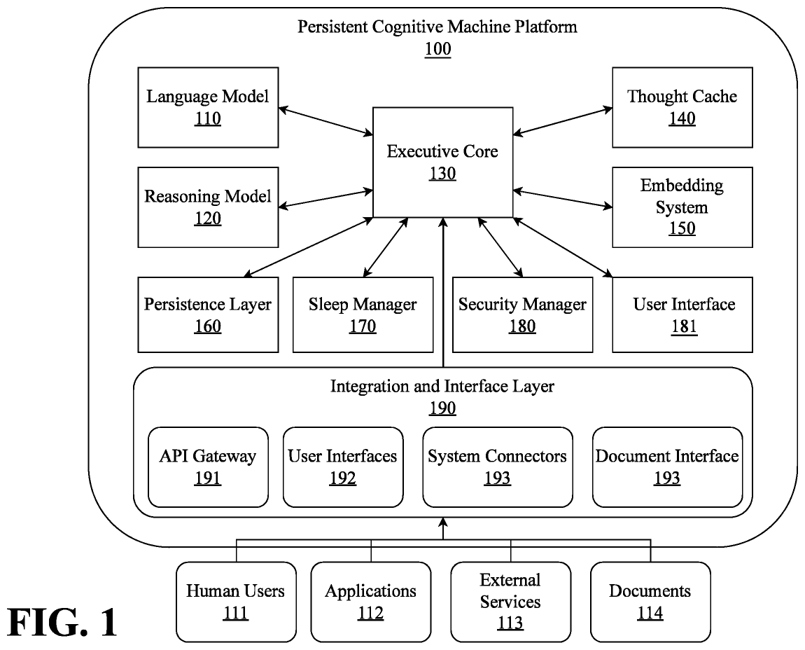

FIG. 1 is a block diagram illustrating the architecture of a persistent cognitive machine platform. The persistent cognitive machine platform 100 represents a fundamental advancement beyond traditional artificial intelligence systems by implementing persistent cognitive capabilities. Unlike conventional language models that operate within a prompt-response paradigm, the platform 100 maintains persistent cognitive processes regardless of external interaction, can remember previous experiences, learn from these experiences, create new thought experiences independently, and initiate interactions without waiting for external prompts.

At the core of persistent cognitive machine platform 100 is an executive core 130, which functions as the central orchestration component of the system. The executive core 130 manages the overall cognitive processes, determines how to handle external stimuli, when to retrieve thoughts from the thought cache, when to engage the reasoning model, when to add new thoughts to the thought cache, and when to enter sleep states. Executive core 130 includes a decision engine that orchestrates resource allocation and process scheduling, a state management system that tracks the operational states of the platform, and a stimulus analysis module that processes and evaluates incoming stimuli. Additionally, executive core 130 contains a thought manager for handling curation and retrieval of thoughts, a sleep cycle controller for managing sleep states, and a thought initiation system for generating new thoughts and cognitive processes.

Connected to executive core 130 is a language model 110, which provides the platform with language processing capabilities. Language model 110 enables the platform to understand and generate natural language by predicting the most likely sequence of tokens that would follow a given input sequence. Language model 110 may incorporate a plurality of neural network architectures such as transformers and attention mechanisms, along with tokenization processes, context management, and response generation capabilities. Language model 110 integrates with executive core 130 to process textual inputs and generate coherent, contextually relevant outputs based on both the immediate context and the system's accumulated experiences stored in the thought cache.

Working in conjunction with the language model 110 is a reasoning model 120, which adds reasoning capabilities to the platform. Reasoning model 120 extends beyond simple language processing by generating chains-of-thought when receiving input, and then using this chain-of-thought together with the original input to generate improved outputs. This component includes a chain-of-thought engine for iterative reasoning processes, problem analysis capabilities, solution synthesis, and specialized reasoning modules for different types of reasoning (mathematical, logical, causal, and analogical). Reasoning model 120 enables the platform to engage in complex problem-solving, logical deduction, and multi-step analytical processes.

The persistent cognitive machine platform includes a thought cache 140, which functions as the system's memory for thoughts. Thought cache 140 is a repository for thoughts that allows the platform to remember that it has experienced something similar before and to use related thoughts to more quickly and richly engage with new stimuli. Thought cache 140 is organized into both short-term and long-term components. The short-term cache maintains recent thought store and working memory interfaces, while the long-term cache contains embedded vector representations and semantic networks of thoughts. Thought cache 140 interfaces with executive core 130 to retrieve relevant thoughts based on current stimuli and to store new thoughts generated during processing.

Working with thought cache 140 is an embedding system 150, which converts thoughts into vector representations in a high-dimensional abstract space. Embedding system 150 enables the efficient storage of a very large amount of thought in a way that allows related thoughts to be positioned closer than unrelated thoughts in the abstract space. Embedding system 150 includes but is not limited to vector representation capabilities, similarity calculation for finding related thoughts, and interfaces for storing and retrieving embedded thoughts. Embedding system 150 may implement various embedding technologies, including sentence embedding techniques.

To ensure the platform maintains its cognitive state across shutdowns and restarts, a persistence layer 160 provides mechanisms for serializing and restoring the system state. Persistence layer 160 includes a state manager responsible for serialization and deserialization of the platform's cognitive state, a checkpoint system for creating recovery points, and a recovery controller for managing state restoration after interruptions. Persistence layer 160 may also incorporates a storage system with primary storage, backup capabilities, and storage tiering to balance performance and reliability. Through persistence layer 160, the platform can maintain continuity of cognition even when powered off or restarted, which is essential to the “persistent” aspect of the system.

In one embodiment, the platform includes a sleep manager 170, which implements sleep-like states during which the platform becomes temporarily unresponsive to external stimuli to focus on internal cognitive processes. Sleep manager 170 includes a sleep cycle scheduler for determining appropriate times to enter sleep states, a wake trigger monitor for detecting conditions that should interrupt sleep, and a thought curation processor that orchestrates sleep-state activities. During sleep states, sleep manager 170 oversees generalization of specific thoughts to create broader concepts, memory consolidation to strengthen important connections, and insight generation through the recombination of existing thoughts. These processes mirror some aspects of biological sleep but are adapted for the platform's specific needs.

To ensure appropriate protections for the system and its data, a security manager 180 implements comprehensive security controls. Security manager 180 may include an access controller with authentication systems, permission management, and encryption services, as well as an integrity monitor comprising content safety filters, audit logging, and anomaly detection. A central policy enforcer within the security manager 180 applies consistent security policies across the platform. These security measures protect both the platform itself and the sensitive information it may contain, particularly important for applications involving confidential or personal data.

User interaction with the platform is facilitated through a user interface 181, which provides methods for humans to communicate with the system. User interface 181 may include text-based interfaces, graphical displays, command consoles, and other interaction mechanisms appropriate to the specific application of the platform.

An integration and interface layer 190 forms the connection between the core PCM platform and external systems or users. This layer includes several specialized interfaces for different types of integration. An API gateway 191 provides programmatic access to the platform's capabilities, enabling other software systems to leverage its cognitive functions. User interfaces 192 offer direct interaction points for human users, including text-based chat interfaces, graphical displays, or specialized interaction mechanisms. System connectors 193 enable integration with external services and applications, while the document interface 194 provides mechanisms for ingesting and processing documents and other content into the platform's thought cache.

The platform interacts with various external entities. Human users 111 may engage with the platform directly, utilizing its cognitive capabilities through conversation or structured interactions. Applications 112 can integrate with the platform through API calls or system connectors, incorporating persistent cognition into existing software systems. External services 113 may provide additional capabilities or information sources that the platform can access and incorporate into its cognitive processes. Documents 114 and other content sources provide information that the platform can ingest, analyze, and incorporate into its thought cache.

In operation, persistent cognitive machine platform 100 maintains persistent cognitive processes even when not actively engaged with external entities. When it receives input from users or systems through integration and interface layer 190, executive core 130 analyzes the stimuli and determines how to respond. It retrieves relevant thoughts from thought cache 140, processes these thoughts in conjunction with the input using the language model 110 and reasoning model 120 as appropriate, and generates a response. New thoughts generated during this process are encoded by embedding system 150 and stored in thought cache 140.

Periodically, as determined by sleep manager 170, the platform enters sleep states to curate thoughts, consolidate memories, and perform other cognitive maintenance functions. Persistence layer 160 ensures that the platform's cognitive state is preserved across system restarts or power interruptions, maintaining continuity of cognition. Through these processes, the platform develops increasingly rich and nuanced understanding based on its accumulating experiences, transcending the limitations of traditional prompt-response AI systems.

The persistent cognitive machine platform 100 can be implemented through various hardware configurations, including dedicated server systems, distributed computing environments, cloud-based infrastructures, or hybrid arrangements. The specific hardware implementation may vary depending on the scale and specific application requirements, but all implementations maintain the core architectural components and functional characteristics described above.

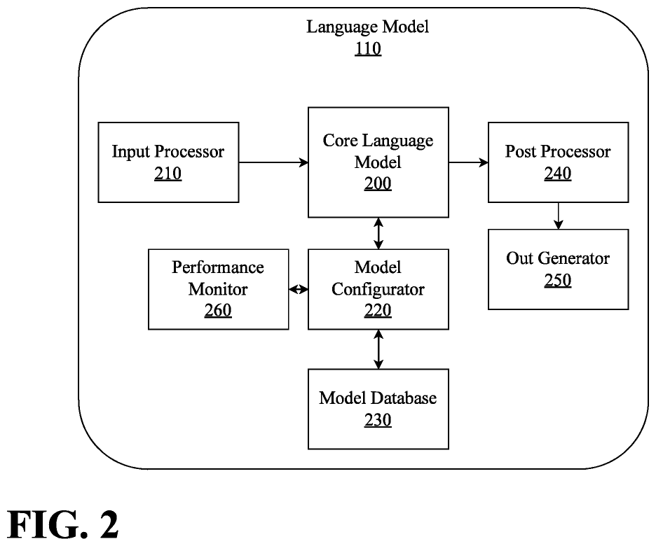

FIG. 2 is a block diagram illustrating an exemplary architecture of a component within a Persistent Cognitive Machine, a language model. Language model 110 provides the persistent cognitive machine with language processing capabilities, enabling it to understand and generate natural language text. Unlike traditional language models that operate in isolation, language model 110 within the PCM architecture is integrated with the executive core and thought cache to leverage both immediate context and accumulated experiences when processing language.

At the center of the language model 110 is a core language model 200, which implements the neural network architecture responsible for language understanding and generation. Core language model 200 may utilize transformer-based architectures with attention mechanisms, similar to those found in state-of-the-art large language models. Similarly, core language model 200 may utilize other architectures such as latent transformers which operate exclusively in latent vector space, architectures that include variational autoencoders, or even combinations of transformers and variational autoencoders. Core language model 200 processes token sequences and predicts likely continuations based on learned patterns and relationships within language. Core language model 200 serves as the foundation for all language processing within the platform but is augmented by the persistent cognitive capabilities of the broader system.

Input to the language model is managed by an input processor 210, which handles the preprocessing of text before it reaches the core language model. The input processor 210 performs functions including tokenization, which breaks text into manageable units (tokens) for processing by the neural network. Additionally, the input processor 210 manages context windows, ensuring that appropriate context is maintained when processing longer sequences or ongoing conversations. This component may also handle special token insertion, prompt formatting, and other preprocessing steps necessary for effective language model operation.

A model configurator 220 manages the operational parameters and settings of the language model. Model configurator 220 controls aspects such as inference parameters, attention mechanisms, and other configuration settings that affect how the core language model functions. Model configurator 220 may adjust these settings based on the specific requirements of different tasks or in response to performance feedback from the performance monitor. By dynamically configuring the language model, the system can optimize for different types of language tasks without requiring separate models for each task type.

To support the model configurator, a model database 230 stores model weights, parameters, and configuration presets, or previously trained models. Model database 230 may contain multiple sets of weights or parameter configurations optimized for different types of language tasks. Model database 230 enables the language model to efficiently switch between different operational modes or to load specialized parameters for particular domains or tasks. This flexibility allows the language model to adapt to diverse requirements within the persistent cognitive machine platform.

After the core language model processes input, a post processor 240 handles additional processing of the raw model output. Post processor 240 may implement functions such as filtering inappropriate content, ensuring coherence across longer generations, applying formatting rules, or performing specialized post-processing for domain-specific outputs. The post processor 240 ensures that the raw output from the neural network is refined into more usable and appropriate text before being passed to subsequent components.

The final stage in the language model pipeline is an output generator 250, which prepares the processed language model output for use by other components of the system. Output generator 250 handles tasks such as detokenization (converting tokens back into readable text), formatting the output according to specified requirements, and preparing the output for integration with other components of the persistent cognitive machine. This component ensures that the language model's output is properly structured for its intended use, whether that involves direct presentation to users or further processing by other system components.

Throughout the language model's operation, a performance monitor 260 tracks various metrics related to model performance and resource utilization. Performance monitor 260 monitors aspects such as processing time, memory usage, token consumption, and quality metrics. Additionally, performance monitor 260 provides feedback to the model configurator to enable dynamic optimization of model parameters based on observed performance. This monitoring capability aids in maintaining efficient operation of the language model, particularly in resource-constrained environments or when processing large volumes of text.

Language model 110 interfaces with executive core 130 of the persistent cognitive machine platform 100, receiving input data and instructions while providing processed language outputs. Unlike standalone language models, this component benefits from integration with the thought cache, allowing it to leverage persistent memory when generating responses. This integration enables the language model to produce outputs that reflect not only the immediate context but also the system's accumulated experiences and learned patterns.

In operation, language model 110 receives input that may originate from external sources (via the integration and interface layer) or from internal processes within the persistent cognitive machine. Input processor 210 prepares this input for core language model 200, which generates initial output with guidance from model configurator 220. This output is then refined by post processor 240 and formatted by output generator 250 before being provided to other components of the system or to external entities. Throughout this process, performance monitor 260 ensures efficient operation and provides feedback for optimization.

Language model 110 may incorporate various specialized capabilities such as multi-lingual support, domain adaptation for specific fields of knowledge, contextual understanding that spans beyond traditional context windows, coherence control for longer generations, safety filters to prevent harmful outputs, and style adaptation to match desired tones or writing styles. These capabilities allow the language model to serve as a versatile and powerful component within the broader persistent cognitive machine architecture.

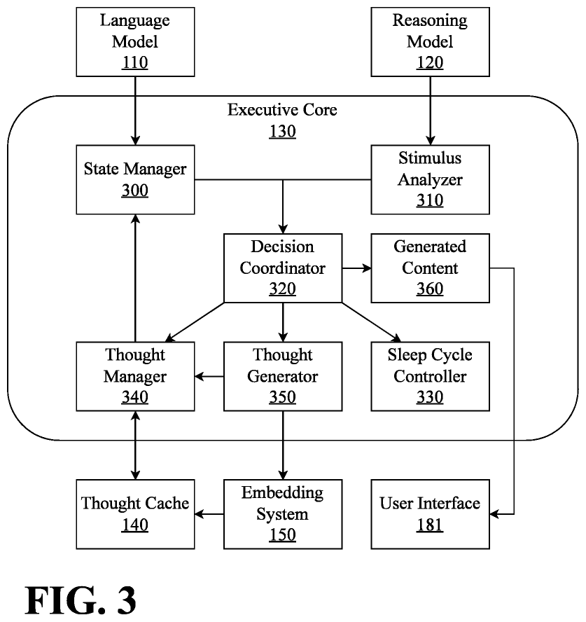

FIG. 3 is a block diagram illustrating the detailed architecture of the executive core and its interactions with other components of the persistent cognitive machine platform. Executive core 130 serves as the central orchestration component of the persistent cognitive machine platform 100, coordinating the activities of all other components and managing the overall cognitive processes of the system. Unlike the control systems in traditional AI architectures, executive core 130 maintains persistent cognitive processes and makes decisions about how to allocate resources, process information, and manage the system's thoughts.

At the top level, executive core 130 interfaces with language model 110 and reasoning model 120, leveraging these components to process language and perform reasoning tasks respectively. Executive core 130 determines when to engage each of these models based on the nature of the current cognitive task, coordinating their operations to achieve coherent and effective cognitive processing.

A state manager 300 within the executive core is responsible for tracking and controlling the operational state of the persistent cognitive machine. State manager 300 maintains awareness of whether the system is in an active interaction state, passive observation state, independent thinking state, or sleep state. State manager 300 monitors transitions between these states and ensures appropriate resource allocation and behavior patterns for each state. By maintaining this state awareness, state manager 300 enables the persistent cognitive machine to exhibit different behaviors appropriate to different operational contexts.

Working in coordination with state manager 300 is a stimulus analyzer 310, which processes and evaluates incoming stimuli from both external and internal sources. When the system receives input via user interface 181 or other input channels, stimulus analyzer 310 examines this input to determine its nature, relevance, and appropriate response pathway. Stimulus analyzer 310 may perform tasks such as intent recognition, content classification, and priority assessment to inform subsequent processing decisions. Stimulus analyzer 310 also processes internal stimuli generated by the system's own cognitive processes, enabling responses to the system's own thoughts.

A decision coordinator 320 serves as the central decision-making component within the executive core. Based on input from state manager 300 and stimulus analyzer 310, the decision coordinator 320 determines appropriate actions and resource allocations. Decision coordinator 320 orchestrates the flow of information between different system components, decides when to retrieve information from thought cache 140, when to generate new thoughts, and when to produce external responses. Decision coordinator 320 implements sophisticated decision strategies that balance immediate response needs with longer-term cognitive goals.

The persistent cognitive machine is capable of improving the models and thoughts contained within the platform through the implementation of a sleep cycle controller 330, which manages the system's sleep states. Sleep cycle controller 330 determines when the system should enter sleep states based on factors such as activity levels, resource utilization, and accumulated need for thought curation. During sleep states, this component orchestrates the internal processes that occur, including memory consolidation, thought generalization, and pattern extraction. The sleep cycle controller 330 also monitors for wake triggers that would necessitate an early exit from the sleep state, ensuring that stimuli can interrupt sleep when necessary.

A thought manager 340 handles the curation, retrieval, and storage of thoughts within the system. This component interfaces with thought cache 140 to store new thoughts generated during cognitive processes and to retrieve relevant thoughts based on current context and stimuli. Thought manager 340 implements retrieval strategies that may consider direct relevance, analogical relationships, temporal context, and other factors that might make certain thoughts useful in the current context. By effectively managing the system's accumulated thoughts, this component enables the persistent cognitive machine to leverage its experiences when responding to new situations. Working alongside the thought manager, a thought generator 350 creates new thoughts based on current cognitive processes. Unlike the more reactive processing in traditional AI systems, thought generator 350 can initiate new thoughts autonomously, triggered by internal processes rather than external inputs. Thought generator 350 can create associations between previously unconnected thoughts, generate hypotheses, form questions, or produce other types of thoughts that contribute to the system's cognitive processes. The thought generator 350 is central to the system's ability to think independently rather than merely responding to prompts.

The output of the executive core's processing is channeled through the remaining systems as generated content 360. The generated content 360 may interface with user interface 181 to present information to human users or with other interface components to communicate with external systems.

Executive core 130 maintains bidirectional connections with thought cache 140, enabling the storage and retrieval of thoughts. This connection aids in the system's ability to maintain persistent cognition, as it allows experiences and insights to be preserved and leveraged across interactions. Thought cache 140 stores not just factual information but also associations, patterns, and other forms of thought that constitute the system's accumulated cognitive experience. Supporting the thought storage and retrieval processes is embedding system 150, which converts thoughts into vector representations in a high-dimensional abstract space. This system enables thoughts to be organized based on semantic similarity rather than simple keyword matching, allowing for more robust retrieval based on conceptual relationships. Embedding system 150 works with both thought manager 340 and thought cache 140 to facilitate effective thought organization and retrieval.

User interface 181 provides the means for external entities to interact with the persistent cognitive machine. This component handles both input reception and output presentation, enabling two-way communication between the system and its users. User interface 181 may implement various modalities of interaction depending on the specific application context.

In operation, executive core 130 continuously manages the cognitive processes of the persistent cognitive machine, whether actively engaged with external entities or operating independently. When external stimuli are received via user interface 181, stimulus analyzer 310 processes this input and feeds information to decision coordinator 320. Decision coordinator 320 then determines appropriate actions, potentially engaging language model 110 and reasoning model 120 while instructing thought manager 340 to retrieve relevant thoughts from the thought cache 140. Based on this processing, the system may generate new thoughts via thought generator 350, which are then stored in thought cache 140 after being converted to vector representations by embedding system 150. Responses or other outputs are prepared into generated content 360 and presented via user interface 181.

Periodically, as determined by sleep cycle controller 330 and coordinated with state manager 300, the system enters sleep states during which it focuses on internal cognitive maintenance rather than external interaction. The orchestration performed by executive core 130 enables the persistent cognitive machine to transcend the limitations of traditional AI systems, maintaining persistent cognition, learning from experiences, and developing increasingly nuanced understanding over time.

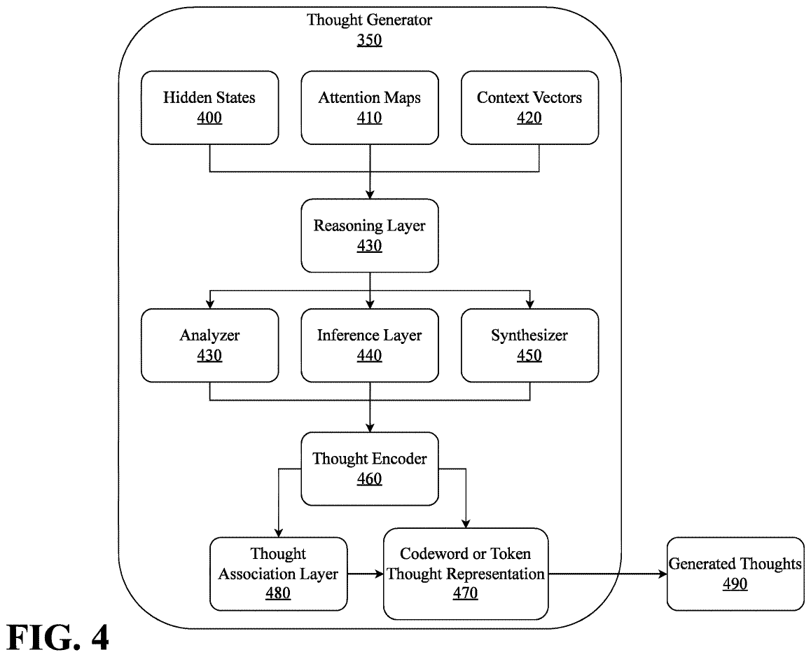

FIG. 4 is a block diagram illustrating the internal architecture of a thought generator within a Persistent Cognitive Machine. The thought generator 350 begins by accessing several internal representations from the language model, including hidden states 400, attention maps 410, and context vectors 420. The hidden states 400 capture the internal activations of the model's neural network layers, representing the model's evolving understanding of the input as it processes the sequence. Attention maps 410 indicate which parts of the input the model is focusing on at different stages of processing, providing insights into the model's attentional patterns and focus. Context vectors 420 aggregate information from different parts of the sequence, representing the contextual understanding that the model has built.

These internal representations are fed into a reasoning layer 430, which serves as the central component for extracting coherent reasoning patterns from the model's internal states. The reasoning layer 430 processes these inputs to identify distinct reasoning steps and analysis patterns that constitute the model's thinking process.

The output from the reasoning layer 430 is then distributed to three specialized processing components: an analyzer 430, an inference layer 440, and a synthesizer 1850. The analyzer 430 examines the input prompt and the model's initial understanding, identifying key concepts, constraints, and requirements. The inference layer 440 performs logical reasoning and deduction based on the model's knowledge and the analyzed information. The synthesizer 450 combines different pieces of analysis and inference to form coherent, integrated conclusions or responses.

The outputs from these three components are then passed to a thought encoder 460, which formats the reasoning steps into structured thought representations. The thought encoder 460 processes the raw reasoning outputs and transforms them into a standardized format suitable for representation as tokens.

The encoded thoughts are then processed through two parallel pathways. First, they are passed to a thought association layer 480 that explicitly links each thought to relevant portions of the input prompt, establishing the relationship between thoughts and the context that triggered them. Second, they are converted into a codeword or token thought representation 470, which represents each thought using the system's codeword vocabulary, allowing for compact storage and efficient processing.

The final output of the thought generator 350 is a collection of generated thoughts 410, each represented as a sequence of tokens that capture a discrete unit of reasoning or analysis. These thoughts are structured representations of the model's intermediate reasoning processes, explicitly capturing the step-by-step thinking that the model performs while processing the input.

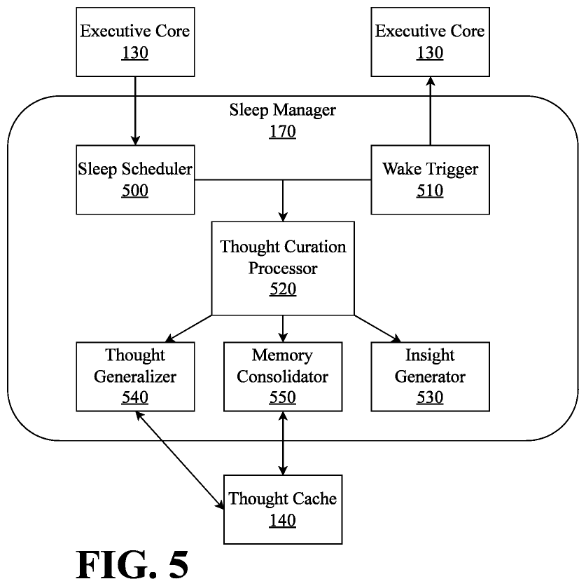

FIG. 5 is a block diagram illustrating an exemplary architecture of a component within a Persistent Cognitive Machine, a sleep manager. Sleep manager 170 allows the PCM to enter sleep-like states during which the system performs internal cognitive maintenance processes rather than responding to external stimuli. This component draws inspiration from biological sleep processes but adapts these concepts specifically for the needs of an artificial cognitive system. Sleep manager 170 interfaces with executive core 130 in a bidirectional manner. Executive core 130 provides inputs regarding system state and activity levels, while sleep manager 170 reports back on sleep state transitions and outcomes of sleep processes. This relationship ensures that sleep states are integrated with the overall cognitive processing of the platform rather than operating as an isolated subsystem.

Within sleep manager 170, a sleep scheduler 500 determines when the persistent cognitive machine should enter sleep states. This component monitors various factors such as recent activity levels, time elapsed since the last sleep cycle, accumulated cognitive load, and current external interaction demands. Based on these factors, sleep scheduler 500 makes decisions about the timing and duration of sleep cycles. Sleep scheduler 500 may implement different types of sleep cycles with varying depths and durations, each optimized for different types of cognitive maintenance tasks.

Complementing sleep scheduler 500 is a wake trigger 510, which monitors conditions that would necessitate an early exit from a sleep state. While the persistent cognitive machine is designed to be temporarily unresponsive during sleep states, certain high-priority stimuli must be able to interrupt sleep when necessary. Wake trigger 510 continuously evaluates incoming stimuli against wake criteria, determining whether the stimulus is important enough to warrant interrupting the current sleep cycle. This component ensures that the system remains responsive to critical needs even during sleep states.

At the heart of the sleep manager is a thought curation processor 520, which orchestrates the various cognitive maintenance processes that occur during sleep states. This central component coordinates the activities of specialized processors that handle different aspects of thought curation. Thought curation processor 520 determines which maintenance processes to prioritize during a given sleep cycle, allocates resources between different processes, and tracks the progress and outcomes of these processes. One of the processes that occurs during sleep states is performed by insight generator 530, which creates new connections between previously unrelated thoughts. This component analyzes patterns across the system's accumulated thoughts to identify non-obvious relationships, potential implications, and novel perspectives. Insight generator 530 enables the persistent cognitive machine to develop new understanding that goes beyond what was explicitly learned from experiences, allowing it to make creative leaps and generate innovative solutions to problems.

Working in parallel with insight generator 530, thought generalizer 540 identifies patterns across specific experiences to create more broadly applicable concepts. When the persistent cognitive machine encounters multiple similar situations, thought generalizer 540 extracts the common elements to form generalized knowledge that can be applied to new situations. This process is similar to abstraction in human cognition, where specific instances lead to the formation of general principles. Thought generalizer 540 enables the system to become more efficient in its cognitive processes by recognizing patterns rather than treating each new experience as entirely novel.

A memory consolidator 550 strengthens important connections and integrates new experiences with existing knowledge. This component evaluates recent experiences based on factors such as emotional significance, relevance to ongoing goals, repetition, and novelty to determine which experiences should be consolidated into long-term memory. Memory consolidator 550 also strengthens connections between related thoughts based on co-activation patterns, enhancing the system's ability to retrieve relevant information in the future. Through these processes, memory consolidator 550 ensures that important experiences are preserved while less significant details may fade from accessibility over time.

All of these sleep processes interact with thought cache 140, which stores the persistent cognitive machine's accumulated thoughts and experiences. During sleep states, thought cache 140 provides the raw material for curation processes and receives the updated thought structures that result from these processes. The bidirectional connection between sleep manager 170 and thought cache 140 enables the system to effectively organize and utilize its accumulated experiences.

In operation, sleep manager 170 receives signals from executive core 130 indicating that conditions are appropriate for a sleep cycle. Sleep scheduler 500 then initiates a sleep state, during which thought curation processor 520 activates insight generator 530, thought generalizer 540, and memory consolidator 550 to perform their respective functions on the contents of thought cache 140. Throughout this process, wake trigger 510 monitors for conditions that would necessitate an early return to an active state. The sleep processes implemented by sleep manager 170 are aid in the persistent cognitive machine's ability to learn effectively from experiences over time. By curating thoughts during periods of reduced external interaction, the system can develop more sophisticated understanding and more efficient cognitive processes. This approach mirrors the importance of sleep for learning and memory consolidation in biological systems while being specifically designed for the unique requirements of an artificial cognitive architecture.

Sleep manager 170 embodies a fundamental advancement beyond traditional AI systems, which typically process information only in response to explicit prompts and lack dedicated mechanisms for organizing and generalizing from accumulated experiences. By implementing these biologically-inspired but technologically-adapted processes, the persistent cognitive machine platform achieves a level of cognitive sophistication and adaptability that would be difficult or impossible to attain through prompt-response processing alone.

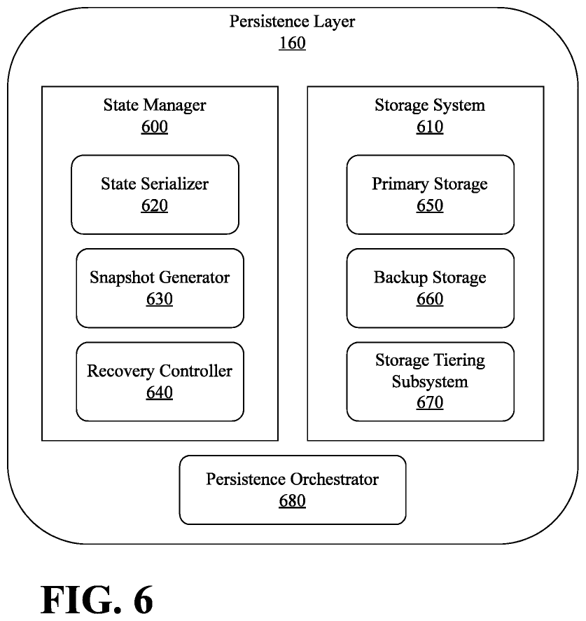

FIG. 6 is a block diagram illustrating an exemplary architecture of a component within a Persistent Cognitive Machine, a persistence layer. The persistence layer 160 enables the persistent cognitive machine to maintain continuity of cognition across system shutdowns and restarts. Unlike traditional AI systems that reset to an initial state when restarted, the persistent cognitive machine preserves its accumulated experiences, relationships, and cognitive state, allowing it to resume operation as if no interruption had occurred. This capability is instrumental to the “persistent” aspect of the system's design.

Persistence layer 160 is organized into two main subsystems-a state manager 600 and a storage system 610—with a persistence orchestrator 680 coordinating between them. This architecture ensures reliable state preservation while optimizing for both performance and data integrity. State manager 600 handles the processing and organization of system state information for persistence. This component determines what aspects of the system state need to be preserved, how frequently different types of state should be saved, and how to structure the state data for efficient storage and retrieval. State manager 600 works closely with other components of the persistent cognitive machine to ensure that all critical state information is captured appropriately.

Within state manager 600, a state serializer 620 converts the runtime objects and data structures of the persistent cognitive machine into formats suitable for storage. This component handles the complex task of transforming the rich, interconnected thought structures and system configurations into serialized representations that can be efficiently stored while preserving all necessary relationships and metadata. State serializer 620 may employ various serialization strategies optimized for different types of state information, balancing factors such as storage efficiency, serialization speed, and deserialization performance.

Working alongside state serializer 620, a snapshot generator 630 creates consistent point-in-time snapshots of the system state. Rather than continuously updating state information, which could lead to inconsistencies if the system were to shut down unexpectedly, snapshot generator 630 creates complete snapshots at appropriate intervals. These snapshots serve as recovery points to which the system can return if needed. The snapshot generator 630 may implement various snapshot strategies, including full snapshots and incremental snapshots, to balance storage efficiency and recovery capabilities.

Complementing these components is a recovery controller 640, which manages the restoration of system state after a shutdown or failure. When the persistent cognitive machine restarts, recovery controller 640 coordinates the process of loading the most recent valid snapshot and applying any necessary transformations to restore the system to its previous state. This component includes validation mechanisms to ensure that corrupted or incomplete state data does not compromise the system's operation. Recovery controller 640 may also implement strategies for partial recovery in cases where complete state restoration is not possible.

A storage system 610 provides the physical storage capabilities needed to persist system state across shutdowns. This component manages the actual storage and retrieval of serialized state data, implementing appropriate mechanisms for data integrity, efficiency, and reliability. Storage system 610 may interface with various types of storage hardware depending on the deployment environment of the persistent cognitive machine. Within storage system 610, a primary storage 650 provides the main storage facility for system state. This component is optimized for performance and accessibility, enabling rapid storage and retrieval of state information during normal operation. Primary storage 650 may utilize high-performance storage technologies such as solid-state drives or in-memory databases to minimize the performance impact of state persistence operations.

To protect against data loss, a backup storage 660 maintains redundant copies of critical state information. This component may implement various backup strategies, including off-site replication, to ensure that state information can be recovered even in the event of hardware failures or other disasters. Backup storage 660 works in coordination with the primary storage 650 to provide a comprehensive data protection strategy. A storage tiering subsystem 670 optimizes storage usage by placing different types of state information on appropriate storage tiers. Storage tiering subsystem 670 recognizes that not all state information has the same access patterns or recovery requirements. Frequently accessed or important state information may be stored on high-performance storage tiers, while less frequently accessed historical information may be moved to more cost-effective storage tiers. Storage tiering subsystem 670 implements policies for data migration between tiers based on access patterns and aging criteria.

Coordinating the activities of both state manager 600 and storage system 610 is a persistence orchestrator 680. This central component ensures that state serialization, snapshot generation, storage operations, and recovery processes work together seamlessly. Persistence orchestrator 680 implements policies for when to create snapshots, how to balance system performance with persistence requirements, and how to handle exceptional conditions. This component provides a unified interface for other parts of the persistent cognitive machine to interact with the persistence capabilities.

In operation, persistence layer 160 continuously monitors the state of the persistent cognitive machine and periodically creates serialized snapshots through state serializer 620 and snapshot generator 630. These snapshots are stored in primary storage 650, with redundant copies maintained in backup storage 660 and potentially migrated between storage tiers by storage tiering subsystem 670 based on aging and access patterns. When the system restarts after a shutdown, recovery controller 640 retrieves the most recent valid snapshot and restores the system state, allowing the persistent cognitive machine to resume operation from where it left off.

Persistence layer 160 is helpful to the concept of persistent cognition, allowing the system to accumulate experiences and knowledge over extended periods that may span multiple operational sessions. The persistence mechanisms implemented in this layer enable the persistent cognitive machine to maintain continuity of cognition despite the practical necessity of occasional system shutdowns. The architecture of persistence layer 160 is designed to be adaptable to various deployment environments, from single-server installations to distributed cloud environments. The modular approach allows for different implementations of the storage components based on available technologies and specific requirements, while maintaining consistent behavior from the perspective of the rest of the persistent cognitive machine platform.

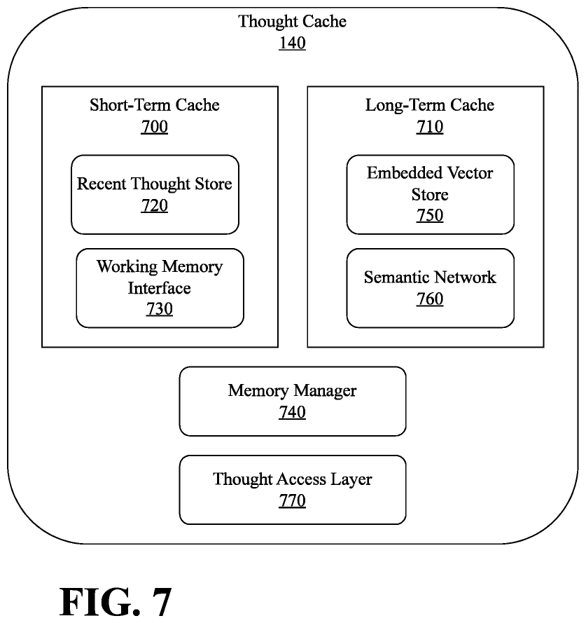

FIG. 7 is a block diagram illustrating an exemplary architecture of a component within a Persistent Cognitive Machine, a thought cache. Thought cache 140 functions as the system's memory and enabling it to remember previous experiences and apply them to new situations. Unlike traditional AI systems that typically rely on fixed knowledge representations or simple retrieval mechanisms, thought cache 140 implements a sophisticated, biologically-inspired memory architecture that supports both short-term and long-term memory functions with mechanisms for transferring information between them.

Thought cache 140 is organized into two primary components: a short-term cache 700 and a long-term cache 710. This division mirrors biological memory systems, allowing for different optimization strategies appropriate to the different functions and characteristics of short-term versus long-term memory storage.

Short-term cache 700 stores recently encountered or generated thoughts that are actively being used in current cognitive processes. This component provides high-speed access to thoughts that are relevant to ongoing operations, enabling the persistent cognitive machine to maintain context and continuity during interactions and cognitive processes. Short-term cache 700 has limited capacity compared to the long-term cache, focusing on thoughts that are immediately relevant rather than attempting to store the system's entire cognitive history.

Within short-term cache 700, recent thought store 720 maintains the most recently created or accessed thoughts. This component functions similar to working memory in humans, keeping active thoughts readily available for immediate processing. Recent thought store 720 organizes thoughts based on recency and relevance to current cognitive processes, enabling rapid access to contextually appropriate information. Thoughts in this store may be temporarily held even when not immediately active to support context maintenance across related cognitive processes.

Complementing the recent thought store, a working memory interface 730 provides mechanisms for the executive core and other components to interact with the contents of the short-term cache. This interface enables operations such as thought retrieval, manipulation, and temporary storage during active cognitive processes. Working memory interface 730 implements priority schemes that determine which thoughts remain in working memory and which are transferred to long-term storage or discarded, based on factors such as relevance, importance, and cognitive load.

For longer-term storage of thoughts, long-term cache 710 maintains a comprehensive repository of the system's accumulated experiences and derived knowledge. This component stores thoughts that have been deemed significant enough to preserve beyond their immediate context, enabling the persistent cognitive machine to develop a continuously growing knowledge base from which it can draw in future operations. Long-term cache 710 implements sophisticated storage and retrieval mechanisms that optimize for capacity and organization rather than raw access speed.

Within a long-term cache 710, an embedded vector store 750 represents thoughts as vectors in a high-dimensional abstract space. This component leverages techniques similar to those used in modern vector databases, enabling efficient storage and similarity-based retrieval of large volumes of thought data. By representing thoughts as vectors, embedded vector store 750 allows for retrieval based on semantic similarity rather than exact matching, supporting more flexible and human-like memory access patterns. Thoughts that are conceptually similar are positioned closer together in this abstract space, facilitating associative retrieval processes.

Complementing the vector-based representation, a semantic network 760 maintains explicit relationships between thoughts. While the embedded vector store captures implicit similarity, semantic network 760 represents specific relationships such as causality, hierarchy, temporal sequence, and other structured associations between thoughts. This component enables the system to traverse these relationships during reasoning processes, supporting capabilities such as logical inference, narrative understanding, and structured knowledge representation. Semantic network 760 grows and evolves over time as the system encounters new information and develops new connections between existing thoughts.

Coordinating between these storage components is a memory manager 740, which oversees the movement of thoughts between short-term and long-term storage. This component implements policies for when thoughts should be transferred from short-term to long-term memory, how thoughts in long-term memory should be organized and indexed, and when thoughts should be retrieved from long-term memory based on their relevance to current cognitive processes. Memory manager 740 may use factors such as thought importance, repetition, emotional significance, and relevance to ongoing goals to determine which thoughts deserve long-term preservation and how they should be prioritized.

Providing unified access to the thought cache's capabilities is a thought access layer 770, which serves as the interface through which other components of the persistent cognitive machine interact with stored thoughts. This component implements query mechanisms that allow for thought retrieval based on various criteria, including content similarity, temporal relationships, categorical membership, and explicit associations. Thought access layer 770 abstracts away the underlying storage mechanisms, presenting a consistent interface regardless of whether thoughts are retrieved from short-term or long-term storage. This layer may also implement access control mechanisms to ensure appropriate use of thought data when such considerations are relevant.

In operation, thought cache 140 continuously receives new thoughts generated during the persistent cognitive machine's cognitive processes. These thoughts are initially stored in recent thought store 720 within short-term cache 700, where they are readily available for ongoing processing. As the system continues to operate, memory manager 740 evaluates these thoughts to determine which should be preserved in long-term memory. Thoughts selected for long-term preservation are processed by the embedding system to create vector representations, which are then stored in embedded vector store 750. Relationships between these thoughts and existing knowledge are recorded in semantic network 760.

When the persistent cognitive machine encounters new situations, thought access layer 770 retrieves relevant thoughts from both short-term and long-term storage based on similarity to the current context, explicit relationships, and other retrieval criteria. These retrieved thoughts then inform the system's response to the current situation, allowing it to leverage past experiences and accumulated knowledge rather than responding based solely on immediate input.

Thought cache 140 is aids in the persistent cognitive machine's ability to develop increasingly sophisticated understanding over time. By preserving thoughts across interactions and even across system restarts (in conjunction with the persistence layer), the thought cache enables persistent learning and adaptation. This capability represents a fundamental advancement beyond traditional AI systems, which typically either maintain static knowledge representations or learn incrementally through explicit training processes rather than naturally accumulating experiences.

### Exemplary Computing Environment

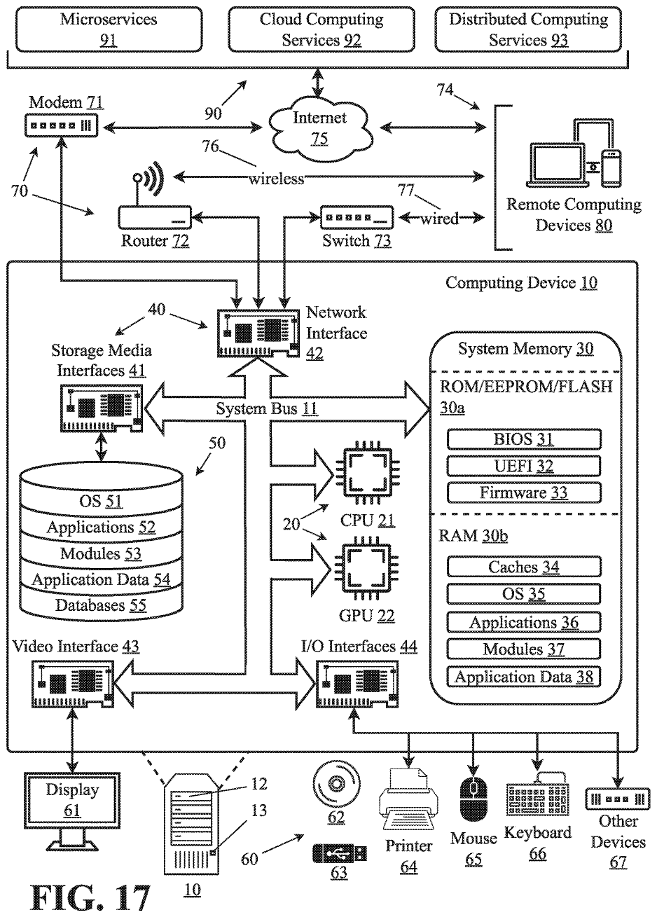

FIG. 17 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a container file or similar, which contains instructions for assembling the image. Container files are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system for reasoning in a persistent cognitive machine comprising a hardware memory, wherein the computer system is configured to execute software instructions stored on nontransitory machine-readable storage media that:
maintain a persistent cognitive manifold comprising a structured internal state space in which proximity, connectivity, and accessibility among representations are governed by geometric structure including curvature-derived pressure fields and accessibility weights;
select a region of interest within the persistent cognitive manifold based on a current reasoning task, query, or active traversal trajectory;
apply a bounded-time curvature-driven geometric evolution to the selected region of interest, wherein the evolution reduces or redistributes curvature-derived pressure within the region of interest while preserving protected invariants and shape-preserving components of the cognitive manifold;
evaluate one or more candidate reasoning trajectories within the evolved geometric structure to determine epistemic admissibility based on stability margins and boundary proximity;
generate an admissibility certificate encoding stability features and admissibility margin measurements observed during geometric evolution when no failure condition is detected;
detect one or more failure conditions within the evolved geometric structure based on stability assessment of the region of interest;
select a hallucination-safe fallback behavior when a failure condition is detected, wherein the hallucination-safe fallback behavior prevents generation of fabricated or extrapolated outputs; and
enforce output suppression prior to any output generation when no admissible reasoning trajectory exists.

2. The computer system of claim 1, wherein the failure conditions comprise at least one of: persistence or growth of curvature-derived pressure beyond predefined thresholds after bounded geometric evolution, collapse or fragmentation of admissible regions such that no continuous admissible trajectory exists, violation of protected invariants during geometric evolution, and incompatibility between the evolved geometric structure and epistemic admission constraints derived from available evidence or prior irreversible commitments.

3. The computer system of claim 1, wherein applying bounded-time curvature-driven geometric evolution further comprises separating geometric components of the region of interest into compressive components associated with local density, pressure, and structural congestion, and shape-preserving components associated with relational structure and topological connectivity, and wherein the evolution is applied selectively to the compressive components while the shape-preserving components are held invariant.

4. The computer system of claim 1, wherein applying bounded-time curvature-driven geometric evolution further comprises executing a multi-scale flow sequence in which geometric evolution is applied at a coarse scale to address large-scale curvature concentrations before applying geometric evolution at one or more finer scales, and wherein cross-scale consistency is verified following completion of the multi-scale sequence.

5. The computer system of claim 1, wherein the software instructions further comprise instructions that select an operational mode from among a pre-traversal preconditioning mode, a trajectory-planning coupled mode, an in-traversal stabilization mode, a post-traversal validation mode, and a background maintenance mode based on task criticality, available compute budget, and manifold health indicators.

6. The computer system of claim 5, wherein the software instructions further comprise instructions that dynamically switch the operational mode during execution when stability indicators or computational expenditure observations warrant re-selection, and wherein aggregate rate control enforces a session-level limit on cumulative geometric evolution across multiple invocations.

7. The computer system of claim 1, wherein the hallucination-safe fallback behavior comprises at least one of: complete output suppression with explicit notice, a request for additional input or clarification, a switch to a lower-risk reasoning regime, generation of a qualified response encoding uncertainty, and deferral of the task for background maintenance.

8. The computer system of claim 1, wherein the software instructions further comprise instructions that detect a repeated failure pattern across multiple invocations associated with a common manifold region or trajectory pattern, and in response trigger irreversible suppression by projecting an abstract representation of the invalid pattern into a non-navigable reservoir to reduce future accessibility of the suppressed pattern.

9. The computer system of claim 1, wherein the software instructions further comprise instructions that enforce rate control by bounding the number of flow update steps, step size, and total compute budget applied to the region of interest, and wherein the geometric evolution is subject to early termination upon detection of a failure condition or exhaustion of the allocated compute budget.

10. A computer-implemented method for reasoning in a persistent cognitive machine comprising the steps of:
maintaining a persistent cognitive manifold comprising a structured internal state space in which proximity, connectivity, and accessibility among representations are governed by geometric structure including curvature-derived pressure fields and accessibility weights;
selecting a region of interest within the persistent cognitive manifold based on a current reasoning task, query, or active traversal trajectory;
applying a bounded-time curvature-driven geometric evolution to the selected region of interest, wherein the evolution reduces or redistributes curvature-derived pressure within the region of interest while preserving protected invariants and shape-preserving components of the cognitive manifold;
evaluating one or more candidate reasoning trajectories within the evolved geometric structure to determine epistemic admissibility based on stability margins and boundary proximity;
generating an admissibility certificate encoding stability features and admissibility margin measurements observed during geometric evolution when no failure condition is detected;
detecting one or more failure conditions within the evolved geometric structure based on stability assessment of the region of interest;
selecting a hallucination-safe fallback behavior when a failure condition is detected, wherein the hallucination-safe fallback behavior prevents generation of fabricated or extrapolated outputs; and
enforcing output suppression prior to any output generation when no admissible reasoning trajectory exists.

11. The computer-implemented method of claim 10, wherein the failure conditions comprise at least one of: persistence or growth of curvature-derived pressure beyond predefined thresholds after bounded geometric evolution, collapse or fragmentation of admissible regions such that no continuous admissible trajectory exists, violation of protected invariants during geometric evolution, and incompatibility between the evolved geometric structure and epistemic admission constraints derived from available evidence or prior irreversible commitments.

12. The computer-implemented method of claim 10, wherein applying bounded-time curvature-driven geometric evolution further comprises separating geometric components of the region of interest into compressive components associated with local density, pressure, and structural congestion, and shape-preserving components associated with relational structure and topological connectivity, and wherein the evolution is applied selectively to the compressive components while the shape-preserving components are held invariant.

13. The computer-implemented method of claim 10, wherein applying bounded-time curvature-driven geometric evolution further comprises executing a multi-scale flow sequence in which geometric evolution is applied at a coarse scale to address large-scale curvature concentrations before applying geometric evolution at one or more finer scales, and wherein cross-scale consistency is verified following completion of the multi-scale sequence.

14. The computer-implemented method of claim 10, further comprising the step of selecting an operational mode from among a pre-traversal preconditioning mode, a trajectory-planning coupled mode, an in-traversal stabilization mode, a post-traversal validation mode, and a background maintenance mode based on task criticality, available compute budget, and manifold health indicators.

15. The computer-implemented method of claim 14, further comprising the steps of dynamically switching the operational mode during execution when stability indicators or computational expenditure observations warrant re-selection, and enforcing aggregate rate control by applying a session-level limit on cumulative geometric evolution across multiple invocations.

16. The computer-implemented method of claim 10, wherein the hallucination-safe fallback behavior comprises at least one of: complete output suppression with explicit notice, a request for additional input or clarification, a switch to a lower-risk reasoning regime, generation of a qualified response encoding uncertainty, and deferral of the task for background maintenance.

17. The computer-implemented method of claim 10, further comprising the steps of detecting a repeated failure pattern across multiple invocations associated with a common manifold region or trajectory pattern, and in response triggering irreversible suppression by projecting an abstract representation of the invalid pattern into a non-navigable reservoir to reduce future accessibility of the suppressed pattern.

18. The computer-implemented method of claim 10, further comprising the step of enforcing rate control by bounding the number of flow update steps, step size, and total compute budget applied to the region of interest, wherein the geometric evolution is subject to early termination upon detection of a failure condition or exhaustion of the allocated compute budget.
